(19) United States
(12) Patent Application Publication
(10) Pub. No.: US 2022/0004994 A1
(43) Pub. Date: Jan. 6, 2022

(54) INTERACTIVE COMMUNICATION SYSTEM

(71) Applicant: Thomas E. Skala, Las Vegas, NV (US)

(72) Inventor: Thomas E. Skala, Las Vegas, NV (US)

(21) Appl. No.: 17/374,176

(22) Filed: Jul. 13, 2021

Related U.S. Application Data
(63) Continuation of application No. 13/437,758, filed on Apr. 2, 2012, now abandoned.
(60) Provisional application No. 61/470,617, filed on Apr. 1, 2011.

(51) Int. Cl. G06Q 10/10; G06Q 30/06; G06Q 30/02

(52) U.S. Cl. CPC G06Q 10/107; G06Q 30/02; G06Q 30/06

(57) ABSTRACT

An automated communication system, including a website template including a base website design including both functional internet and functional phone communication features, and executable machine-readable software instructions for automatically producing a customized website by using the base website design, user metadata from a user account, and media information, a network bridge functionally coupled to each of a network data system and a phone data system and thereby functionally coupling the network data system to the phone data system, a bridge controller functionally coupled to the website template and operatively coupled to the network bridge and that includes instructions for managing data transfer across the network bridge that permit control of the functional phone communication features via interaction with the customized website produced from the website template, and a user account module in communication with the bridge controller and that includes account information of system users on a data storage device.

### CROSS-REFERENCE TO RELATED APPLICATIONS

This invention claims priority, under 35 U.S.C. § 120, to the U.S. Non-Provisional patent application Ser. No. 13/437,758 to Thomas E. Skala fled on Apr. 2, 2012, and therethrough to the U.S. Provisional Patent Application No. 61/470,617 to Thomas E. Skala filed on Apr. 1, 2011, both of which are incorporated by reference herein in their entirety.

### BACKGROUND OF THE INVENTION

### Field of the Invention

The present invention relates to communication systems, specifically to an interactive communication system and method.

### Description of the Related Art

Telecommunication is the transmission of information over significant distances to communicate. In earlier times, telecommunications involved the use of visual signals, such as beacons, smoke signals, semaphore telegraphs, signal flags, and optical heliographs, or audio messages via coded drumbeats, lung-blown horns, or sent by loud whistles, for example. In the modern age of electricity and electronics, telecommunications now also includes the use of electrical devices such as the telegraph, telephone, teleprinter, personal communication devices, computers, laptops, as well as the use of radio and microwave communications, as well as fiber optics and their associated electronics, plus the use of the orbiting satellites and the Internet.

Some improvements have been made in the field. Examples of references related to the present invention are described below in their own words, and the supporting teachings of each reference are incorporated by reference herein:

U.S. Pat. No. 5,742,763, issued to Jones, discloses a message delivery system, for use with a communication network and in which a network presence is provided for an entity having attributes, delivers a message from a sender to the network presence. In some cases, information identifying the sender is omitted from the message. The delivery system can append non-repudiable sender information to the message. The sender can provide selected attributes as an address, and the delivery system replaces the selected attributes with an address of the network presence without disclosing the address to the sender. A software agent processes the delivered message in accordance with a processing preference included in the entity attributes.

U.S. Pat. No. 7,840,209, issued to Kwon et al., discloses a reply voice message transmission system and method thereof for transmitting a reply voice message showing whether a voice message from a sender is received by receiver's pressing a predetermined key in a mobile phone in the course of or after hearing the voice message from the sender, in case that a voice message from the sender is transmitted to a receiver. The method comprises the steps of: a) registering a voice message from a sender; b) discriminating whether the registered voice message is confirmed by a receiver, and then storing the message in a database sequentially, in case that the voice message is not confirmed by the receiver, c) recording a reply voice message from the receiver in the course of or after hearing the voice message from the sender, in case that the voice message is confirmed by the receiver in the step (b); and d) transmitting the recorded reply voice message to a sender's mobile phone.

U.S. Pat. No. 6,330,079, issued to Dugan et al., discloses a platform for use in a communications system integrates voicemail and faxmail functionality. The platform collects, stores, and retrieves voicemail and faxmail messages for numerous subscribers. Each subscriber accesses his or her account with, for example, a single telephone number assigned to the subscriber. The integrated voicemail and faxmail platform collects, stores, forwards, distributes, saves, deletes, and retrieves voicemail and faxmail messages for the numerous subscribers based on the single number. The platform also provides capability for enhanced features such as automatic callback to individuals who leave a message for a subscriber, broadcasting of fax messages to multiple recipients, and the creation and management of distribution lists for voicemail and faxmail messages.

U.S. Pat. No. 6,732,332, issued to Borysewicz et al., discloses a system of creating Internet web content. In some embodiments, non-web content is received in a web content creation module, which automatically creates web content from the non-web content. In select further embodiments, an organizational database is then updated with information comprising web content structure information associated with the created web content, incorporating the web content into the web page.

U.S. Patent Application Publication No.: 2006/0258380, by Liebowitz et al., discloses processes and systems for interactive opt-in messaging. A mobile phone user may enroll in a content delivery service at the invitation of a broadcast program. A content program may then be delivered to the mobile phone. The content program may include a series of messages having interest content and solicitation content. The solicitation content may include a solicitor phone number. A user of the mobile phone may respond to the solicitation content from the mobile phone without having to re-key the solicitor phone number.

The inventions heretofore known suffer from a number of disadvantages which include being limited in use, being limited in application, being complex, being difficult to use, being expensive, being limited in function, being unsecure, requiring too much time to prepare and/or deploy, failing to provide sufficient means for communication, failing to interact with viewers in a manner that is convenient for the viewers, too severely restricting the options of the user and/or the viewer, requiring too high a level of computer expertise to implement, requiring expensive equipment to implement, being slow to implement/deploy, failing to provide a shopping function or any of the other functions described herein, failing to connect calls, requiring communicators to satisfy rigid technical requirements, failing to communicate between platforms, charging/costing per communication, failing to integrate multimedia file handling capabilities, failing to generate a web-presence, failing to coordinate services, failing to protect privacy, failing to promote widespread use, and the like and combinations thereof.

What is needed is an interactive communication system that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available interactive communication systems. Accordingly, the present invention has been developed to provide one or more systems, devices, tools, methods, and the like to provide enhanced communications and/or to automate the facilitation of the same.

In one embodiment, there is a an automated computerized website building system, that may include: an internet-telephony bridge module that may be configured to bridge network data and/or telephony data; a bridge control module that may be operatively coupled to the internet telephony bridge module and/or that may be configured to manage data transfer across the internet-telephony bridge; a user account module that may be in communication with the bridge control module and/or that may be configured to store account information of system users; a website template module that may be configured to provide a base website design that may be including both internet and telephony communication features; and/or a website customization module that may be in communication with the user account module the website template module and/or that may be configured to permit a user having a user account stored thereon to supply media information and/or user metadata for display and/or operation, respectively, on a website that may be built across the base website design of the website template module. One or more of the other modules described herein, named or otherwise, may be included in such a system.

In another embodiment, there may be a computerized communications hub system, that may include: a genie gateway module that may be in communication with a web-based network and a telephony communication network, the genie gateway module that may include: an audio/video module that may be configured to provide access to media files; a virtual merchant module that may be configured to provide shopping functions thereby permitting a viewer to purchase goods from an operator of the genie gateway module; a messaging module that may be configured to permit a viewer to send a text or voice message to an operator of the genie gateway module; a fax module that may be configured to permit a viewer to send a FAX to an operator of the genie gateway module; an opt-in module that may be configured to permit a viewer to opt-into a messaging service associated with the genie gateway module; a web-based user interface module that may be configured to provide a viewer with web-based access to the modules of the genie gateway module; and a telephone module that may be configured to selectively initiate a telephone call between a viewer and an operator of the genie gateway module. One or more of the other modules described herein, named or otherwise, may be included in such a system.

In still another embodiment of the invention, there may be a method of facilitating communications between web-based and telephony networks, that may include one or more of the steps of: providing a web-based interface that may include selectable options for initiating communications between one or more web-based communication tools and one or more telephony based communication tools; providing access to a network bridge that may be configured to bridge communications between a telephony network and a web-based network; automatically generating a web-based interface, in communication with the network bridge, from user account data for a user having telephony services; initiating a communication between a web-based network and a telephony based network on receipt of a request from the automatically generated web-based interface. One or more of the other function, actions, operations, and etc. described herein, named or otherwise, may be included in such a method.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawing(s). It is noted that the drawings of the invention are not to scale. The drawings are mere schematics representations, not intended to portray specific parameters of the invention. Understanding that these drawing(s) depict only typical embodiments of the invention and are not, therefore, to be considered to be limiting its scope, the invention will be described and explained with additional specificity and detail through the use of the accompanying drawing(s), in which:

FIG. 1 is a network diagram of an interactive communication system, according to one embodiment of the invention;

FIG. 2 is a module diagram of a genie gateway module of an interactive communication system, according to one embodiment of the invention;

FIGS. 3-17 are screenshots of exemplary user interfaces of a genie gateway module of an interactive communication system, according to one embodiment of the invention;

FIG. 18 is a diagram of an automated computerized website building system according to one embodiment of the invention; and

FIG. 19 illustrates a method of facilitating communications between web-based and telephony networks, according to one embodiment of the invention.

### DETAILED DESCRIPTION OF THE INVENTION

For A purposes of promoting an understanding of the principles of the invention, reference will now be made to the exemplary embodiments illustrated in the drawing(s), and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of programmable or executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module and/or a program of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

The various system components and/or modules discussed herein may include one or more of the following: a host server or other computing systems including a processor for processing digital data; a memory coupled to said processor for storing digital data; an input digitizer coupled to the processor for inputting digital data; an application program stored in said memory and accessible by said processor for directing processing of digital data by said processor; a display device coupled to the processor and memory for displaying information derived from digital data processed by said processor; and a plurality of databases. As those skilled in the art will appreciate, any computers discussed herein may include an operating system (e.g., Windows Vista, NT, 95/98/2000, OS2; UNIX; Linux; Solaris; MacOS; and etc.) as well as various conventional support software and drivers typically associated with computers. The computers may be in a home or business environment with access to a network. In an exemplary embodiment, access is through the Internet through a commercially-available web-browser software package.

The present invention may be described herein in terms of functional block components, screen shots, user interaction, optional selections, various processing steps, and the like. Each of such described herein may be one or more modules in exemplary embodiments of the invention. It should be appreciated that such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, the software elements of the present invention may be implemented with any programming or scripting language such as C, C++, Java, COBOL, assembler, PERL, Visual Basic, SQL Stored Procedures, AJAX, extensible markup language (XML), with the various algorithms being implemented with any combination of data structures, objects, processes, routines or other programming elements. Further, it should be noted that the present invention may employ any number of conventional techniques for data transmission, signaling, data processing, network control, and the like. Still further, the invention may detect or prevent security issues with a client-side scripting language, such as JavaScript, VBScript or the like.

Additionally, many of the functional units and/or modules herein are described as being “in communication” with other functional units and/or modules. Being “in communication” refers to any manner and/or way in which functional units and/or modules, such as, but not limited to, computers, laptop computers, PDAs, modules, and other types of hardware and/or software, may be in communication with each other. Some non-limiting examples include communicating, sending, and/or receiving data and metadata via: a network, a wireless network, software, instructions, circuitry, phone lines, internet lines, satellite signals, electric signals, electrical and magnetic fields and/or pulses, and/or so forth.

As used herein, the term “network” may include any electronic communications means which incorporates both hardware and software components of such. Communication among the parties in accordance with the present invention may be accomplished through any suitable communication channels, such as, for example, a telephone network, an extranet, an intranet, Internet, point of interaction device (point of sale device, personal digital assistant, cellular phone, kiosk, etc.), online communications, off-line communications, wireless communications, transponder communications, local area network (LAN), wide area network (WAN), networked or linked devices and/or the like. Moreover, although the invention may be implemented with TCP/IP communications protocols, the invention may also be implemented using IPX, Appletalk, IP-6, NetBIOS, OSI or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997), the contents of which are hereby incorporated by reference.

Reference throughout this specification to an “embodiment,” an “example” or similar language means that a particular feature, structure, characteristic, or combinations thereof described in connection with the embodiment is included in at least one embodiment of the present invention. Thus, appearances of the phrases an “embodiment,” an “example,” and similar language throughout this specification may, but do not necessarily, all refer to the same embodiment, to different embodiments, or to one or more of the figures. Additionally, reference to the wording “embodiment,” “example” or the like, for two or more features, elements, etc. does not mean that the features are necessarily related, dissimilar, the same, etc.

Each statement of an embodiment, or example, is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The features, functions, and the like described herein are considered to be able to be combined in whole or in part one with another as the claims and/or art may direct, either directly or indirectly, implicitly or explicitly.

As used herein, “comprising,” “including,” “containing,” “is,” “are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of.”

Any of the features, functions, processes, methods, steps, algorithms, benefits, operations, and the like described herein may be performed by operation of one or more modules, described herein or otherwise and such modules may be identified or named by associating the description of the performance, end result, operation or the like with the term “module.” Such modules may be interconnected by sharing, transferring, using, or otherwise interacting on a data level, such as but not limited to issuing commands, storing data for later use by one or more modules, providing access to one or more functions of a module to another module, and the like and combinations thereof.

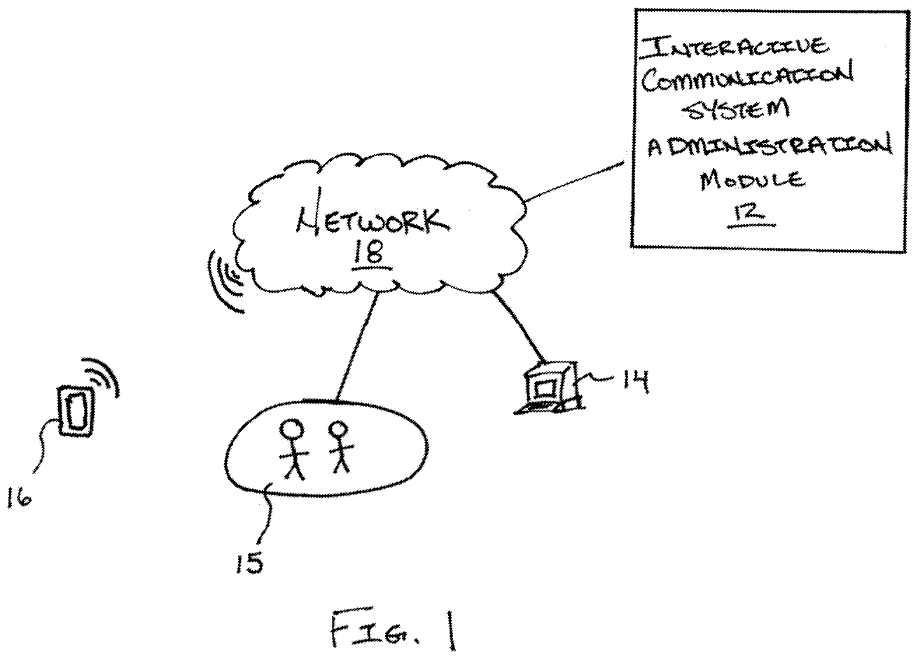

FIG. 1 is a network diagram of an interactive communication system, according to one embodiment of the invention. There is shown an interactive communication system administration module 12 in communication with a computer 14 and a personal communication device 16, such as a smart phone over a network 18 in a manner that permits third party viewers 15 to interact with the same.

The illustrated interactive communication system administration module 12 is configured to manage and operate a plurality of genie gateway modules that are used through personal communication devices, such as a smart phone 16 or a computer or a computing device 14. The interactive communication system administration module 12 is in communication with the personal communication device 16 and the computer 14 over a network 18. A plurality of visitors 15 are configured to be able to view the contents or data distributed by a genie gateway module, and are configured to respond without having to sign up for a genie gateway module. Visitors 15 are given an option to join or sign up for a free version of a genie gateway module, upon viewing contents sent by a genie gateway module.

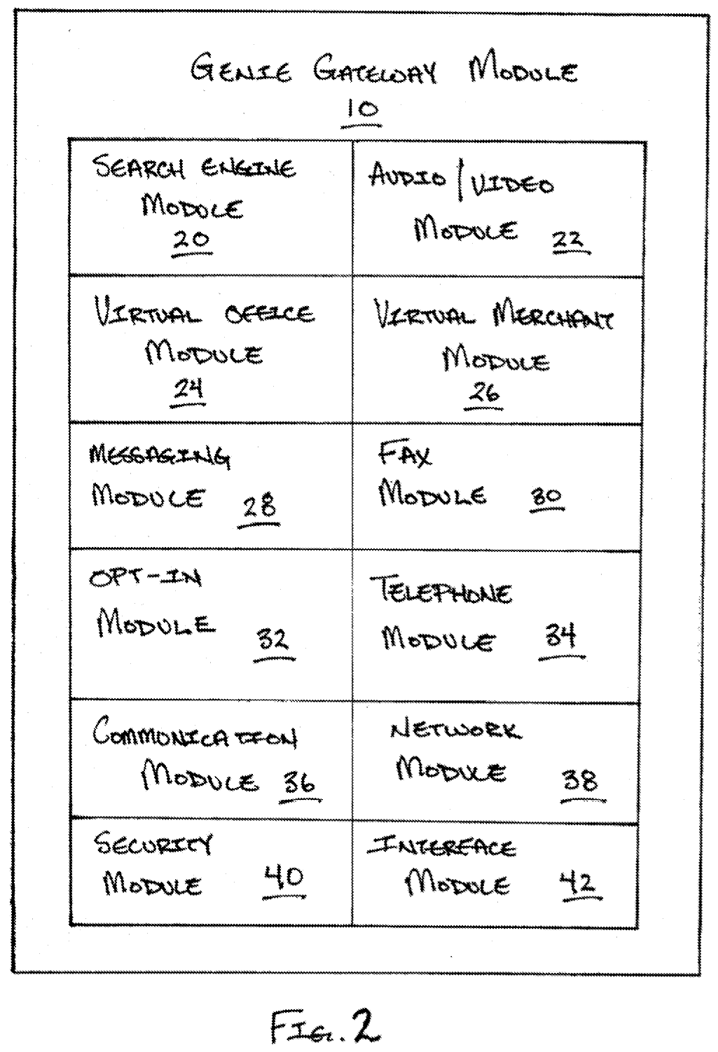

FIG. 2 is a module diagram of a genie gateway module of an interactive communication system, according to one embodiment of the invention. There is shown a genie gateway module 10 including a search engine module 20, an audio/video module 22, a virtual office module 24, a virtual merchant module 26, a messaging module 28, a fax module 30, an opt-in module 32, a telephone module 34, a communication module 36, a network module 38, a security module 40, and an interface module 42.

The illustrated genie gateway module 10 is configured to combine telecommunications, television, internet and electronic banking into one seamless global communication service. The genie gateway module 10 is configured to provide a website with search engine optimizations, a computing device, a telephone system (landline or cellular; traditional or “smart”), a text messaging system, a GenieVOX Voice SMS system, an audio services system, a video services system, an email system, a fax services or a virtual fax machine system, a television network system, a document delivery system, a virtual office/unified communications system, a virtual merchant system, and/or an opt-in web-smart phone application system.

The genie gateway module 10 is configured to deliver all of the above mentioned services from a single source on a single platform in a single cloud to a user. The genie gateway module 10 is configured to transfer information/data from process to process on the same platform, rather than from system to system, or even from provider to provider, like a conventional communication system. The genie gateway module 10 is configured to provide faster, more tightly integrated services with security, privacy, and safety, at a lower cost than any multi-platform communication system. The genie gateway module is configured to expand the concept of communications, which traditionally involves simple telephone calls or text messages being delivered through a single entry point across a single medium to a single destination. Instead, the genie gateway module 10 is configured to allow the communications to be more complex, be submitted through varying entry points, and be transmitted across multiple media to multiple destinations.

The genie gateway module 10 is configured to provide a multi-media communications hub to provide additional business-to-business and business-to-consumer functionality. The genie gateway module 10 includes all the fundamental inventions of a secure messaging system, allowing brief messages to be submitted through varying entry points, and transmitted across multiple media to multiple destinations, with the same in-channel response to the submitted messages.

The genie gateway module 10 is configured to allow visitors to a subscriber's genie gateway module 10 to also connect with the subscriber's virtual office, to speak, join a conference, send a VOX, send a FAX, send documents and audio files, from any internet enabled device, from anywhere worldwide, free of charge. When a visitor to a subscriber's genie gateway module 10 decides to make a purchase of goods or services, the transfer of funds to the subscriber may be accomplished from any third party, whether or not said third party is also a subscriber. Furthermore, the genie gateway module 10 also incorporates a set of interesting mechanisms whereby the subscriber's customers can listen to audio presentations, watch video presentations and print brochures on any internet enabled device. Subscribers may update their audio, video or downloadable text content generally at any time through a web interface. They may also update their audio content generally at any time via a telephone call.

The genie gateway module is a web, email, Smartphone, television, web page, created by and for each individual subscriber specifically through an interactive online process. Both the client, and its creation process, is aimed squarely at businesses and individuals who want a fully rounded presence in the multi-media world without the cost and complexity of the build-it-yourself approach.

The genie gateway module 10 is configured to provide all the benefits of a website and online multi-media web-presence, even if subscribers do not have their own website. With a single click by a friend, family member or a business associate, the genie gateway subscriber can receive a telephone message, a text message or an email (or all three) with a short text message to advise them that someone wants to contact them and why. Subscribers can, at their option, call back, email, text or VOX their party, at their convenience. All aspects of the communication in both directions are handled directly through the single underlying platform, in one secure cloud.

The genie gateway module 10 is configured to publish recorded messages. The genie gateway module 10 is configured to record messages and updates from any phone, and all visitors can click and listen to updates anywhere, free of charge. The genie gateway module 10 is configured to display documents and brochures. The genie gateway module 10 is configured to upload any Microsoft Office or Open Office document from a computing device. The genie gateway module 10 may display a printable PDF document to all visitors.

The genie gateway module 10 is configured to show videos. The genie gateway module 10 is configured to upload a link to videos from a website, YouTube, or any other service provider. The genie gateway module 10 also includes an opt-in app for updates. The genie gateway module 10 is configured to convert visitors into potential customers in seconds by inviting them to opt in for updates.

The genie gateway module 10 includes an “one-click” way for anyone to reach them. The genie gateway module 10 is a web/email tool that links people to them, free of charge, from anywhere in the world. The “one-click” way for any business or individual to be reached with unified messaging, group messaging, voice & emergency messaging, private & social network messaging, without giving up privacy.

The genie gateway module 10 is configured to provide click-to-connect phone calls free worldwide. Visitors to the genie gateway module 10 may click on a genie number displayed and be connected from the web enabled device. The genie gateway module 10 is configured to send and receive genieVOX. GenieVOX (Voice SMS) is a blending of the power of voice messaging with the ease and flexibility of text messaging. VOX allows subscribers to send and receive short spoken messages with one person or thousands, quickly and easily.

The illustrated genie gateway module 10 includes a search engine module 20 configured to provide a search engine to search a network for desired terms or products. The genie gateway module 10 includes an audio/video module 22 configured to provide audio/video capabilities to the genie gateway module 10. The audio/video module 22 is configured to send, receive, publish, and/or broadcast an audio or video message from the genie gateway module 10.

The genie gateway module 10 includes a virtual office module 24 configured to provide office software tools to the genie gateway module 10. The virtual office module 24 includes a document system, a power point system, a spreadsheet system, an accounting system, a scheduling system, a project management system, etc.

The genie gateway module 10 includes a virtual merchant module 26 configured to provide merchant and consumer capabilities to the genie gateway module 10. The virtual merchant module is configured to include purchasing capabilities, selling capabilities, banking options such as fund transfers, an inventory system, a CRM system, a management/administration system, etc. The virtual merchant module 26 includes a virtual point-of-sale system (VPOS). The web visitor may view and purchase goods and services that the subscriber offers for sale. The web interface will display images, descriptions and prices of items, as uploaded and entered by the subscriber. Purchases may be completed by use of several major credit cards, or by use of funds in the web visitor's own Genie account, if they are also a subscriber.

The virtual merchant module 26 and the virtual point-of-sale system (VPOS) is configured to transfer funds. Each genie gateway module includes, if the subscriber chooses, a stored-value instrument called a GenieCard. Subscribers to the GenieCard have use of two additional, related services for carrying on sales and other related activities.

The virtual merchant module 26 is a sales tool connected to the subscriber's Genie Account through the telephone interface. Callers to the subscriber's Genie Number can press a key on their touch-tone keypad, and then follow spoken prompts to enter a dollar amount, their credit card information, and a recorded message describing what the funds are for. The system will process a transaction against the caller's credit card, deposit the funds into the subscriber's GenieCard account, and send a copy of the recorded message along with a description of the amount remitted, as well as details of the caller's phone number to one or more email addresses designated by the subscriber. Up to three email addresses can be specified in the current implementation. The subscriber is then able to fulfill the caller's request appropriately by shipping merchandise, or taking other actions as indicated.

The virtual point-of-sales system (VPOS) is configured to extend the concepts of the Virtual Merchant to the Genie Gateway web interface. The subscriber is able to enter a series of item descriptions and pricing information, along with uploaded images showing the product or products described. Visitors to the web site are then able to view the images, descriptions and prices, from which they can select one or more item(s) to purchase. Upon selecting an item or items, they are then prompted to enter credit card information as well as shipping location details. Upon completion of the transaction by the visitor, the system will process a transaction against the visitor's credit card, deposit the funds into the subscriber's GenieCard account, and send a description of the purchase, the amount remitted, and other details entered by the visitor to one or more email addresses designated by the subscriber. Up to three email addresses can be specified in the current implementation. The subscriber is then able to fulfill the visitor's purchase request appropriately by shipping merchandise, or taking other actions as indicated.

Credit Card vs. Genie Account Remittances—The Virtual Merchant and VPOS functions will each accept both Credit Card and Genie Account sources as valid methods of remittance. One key difference is that, in the case of Genie Account remittance, all transactions remain entirely on the system platform. As a result, these transactions occur in real time, with immediate funds availability to the subscriber. In contrast, credit card transaction generally must be verified against the card provider's authorization systems. As a result, credit card transactions are subject to both practical and regulatory delays and limitations.

The genie gateway module 10 includes a messaging module 28 configured to provide messaging capabilities to the genie gateway module 10. The messaging module 28 is configured to send and receive secure emails, text messages, voice messages, telephone messages, video messages, broadcasts, faxes, document delivery, video calls, etc. The genie gateway module 10 includes a fax module 30 configured to provide fax capabilities to the genie gateway module 10. The fax module 30 is configured to provide fax services and virtual fax machines to the genie gateway module 10.

The genie gateway module 10 includes an opt-in module 32 is configured to provide subscribing capabilities to visitors or other non-subscribing users to subscribe to receive updates and broadcasts from a genie gateway module and subscriber. The opt-in module 32 is an application configured to produce special codes that allow someone to be instantly added to a subscriber's information distribution lists, their SendTEXT, SendWAV and Opt-In PhoneBooks.

The opt-in module 32 is configured to provide an one-click way for people to opt in to receive a subscriber's updates and announcements. Subscribers is configured to send their messages anytime, free, to one or thousands with a single click, in the three most common methods of communication, voice, text, and email. The opt-in module 32 is configured to ask the user to enter their name, telephone number and email address. Once they complete this process they are automatically added to the subscriber's SendTEXT and Main PhoneBooks. The subscriber is configured to send them announcements, deals, news and updates anytime and may automatically receive a free version of a genie gateway module. The opt-in module is configured to be copied into the body of most commercially available email documents, websites, electronic brochures, coupons, or word processor created documents and spreadsheets.

The opt-in module includes an opt-in phonebook module configured to enable subscribers to take control of sending and receiving voice messages. The phonebook module is configured to enable subscribers to send messages to many people at once. The addition of the opt-in phonebook module is configured to assure that recipients have actively indicated that they wish to receive messages from a given subscriber. The opt-in module 32 includes special security features configured to ensure that only those screened and approved are added to a subscriber's opt-in list and no one may add someone else.

The opt-in module 32 is configured to avoid unsolicited or unwanted opt-ins, subscribers receive an email with the caller's phone number and the name they recorded. Then the subscriber calls their Genie Number and approves the addition. Thus, both the service subscriber and the person who opts-in know that the subscriber's messages and announcements are something they really did ask to receive. The opt-in module 32 is configured to allow someone who has opted-in to a particular subscriber's messaging, to opt-out generally at any time. An opt-out event also generates a notification email to the subscriber, but does not require a follow-up approval step.

The genie gateway module 10 includes a telephone module 34 configured to provide telephone communication capabilities over a secure network. The telephone module 34 may be in communication with a landline or a cellular phone, either a smart phone or a regular traditional cell phone.

The genie gateway module 10 includes a communication module 36 configured to provide wireless communication and hard line communication capabilities to the genie gateway module 10. Non-limiting examples of a communication module may be but not limited to: a communication module described in U.S. Pat. No. 5,307,463, issued to Hyatt et al.; or a communication module described in U.S. Pat. No. 6,133,886, issued to Fariello et al. which are incorporated for their supported herein.

The genie gateway module 10 includes a network module 38 in communication with a network. The network module 38 is configured to send, receive, or broadcast a television network data or a television feed over the genie gateway module 10. The genie gateway module 10 includes a security module 40 configured to provide secure communications through the genie gateway module 10. The security module 40 includes encryptions, passwords, pass codes, etc. to ensure the security of its users.

The genie gateway module 10 includes an interface module 42 configured to provide interface controls to the genie gateway module 10. The interface module 42 is configured to permit a user to stock the VPOS portion of their genie gateway module 10. Such an interface includes one or more modules configured to accept such information and deploy received information within the VPOS to permit viewers of the page to purchase such items.

The genie gateway module 10 is configured to store identifying data, such as a name or a telephone number for record-keeping purposes. The genie gateway module 10 also includes hardware, such as hardware that is involved in the path used to permit audio recordings made by the customer on the phone to be posted on the genie gateway module 10.

In one embodiment of the invention, traditional T1's circuits are plugged into a server through a media board that includes trunk connectivity interfaces (for T1 or E1), computer bus connectivity (e.g. PCI bus interface, etc.) and the like. Such may also include H.100 bus connectivity to permit boards to share data. In one non-limiting example a Dialogic C6565 board (PCI media board) manufactured by Dialogic Corporation of Quebec Canada may be installed in a server utilizing an operating system, such as but not limited to Windows 2003, Linux and the like and combinations thereof.

There may be an executable, driver, and or script operating on a computing device, such as but not limited to a server and/or a file server that may manage operation of the media board that may instruct the same to capture, manipulate and/or save audio recordings, such as but not limited to audio recordings made over a telephone to a file server or other storage device. Such a program may write customer records to a database server associating the audio recordings to the customer. A web server may be scripted and/or otherwise managed in a manner that allows such recordings to be served to a web interface, such as but not limited to a genie gateway module, and thereby provide access to the audio recordings to viewers of the web page.

In one embodiment of the invention, there may be an executable, driver, and/or script that may control a media board and instructs the same to send audio recordings to a Linux email server with an SMS email address of the customer.

In similar manners data may be bridged between the telephony aspects of the embodiments of the invention and the internet aspects of the invention, thereby permitting users and viewers of the genie gateway module to easily interact across platforms to the advantage of those involved.

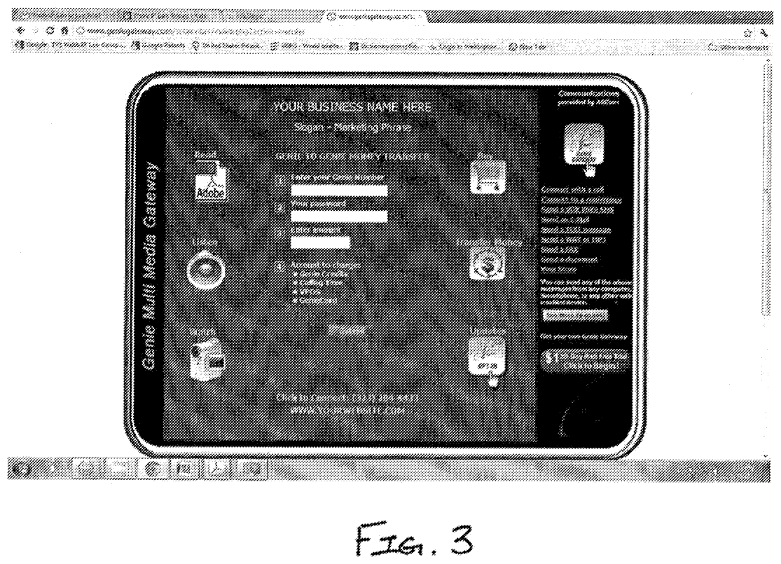

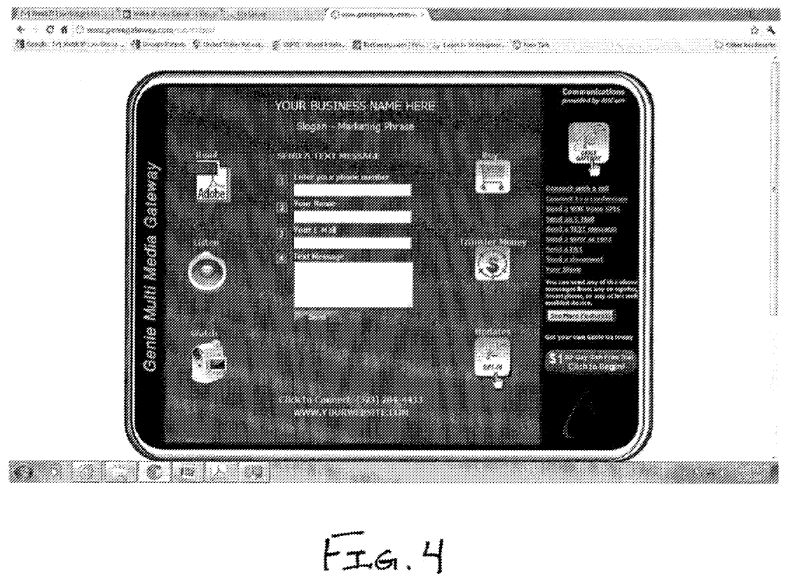

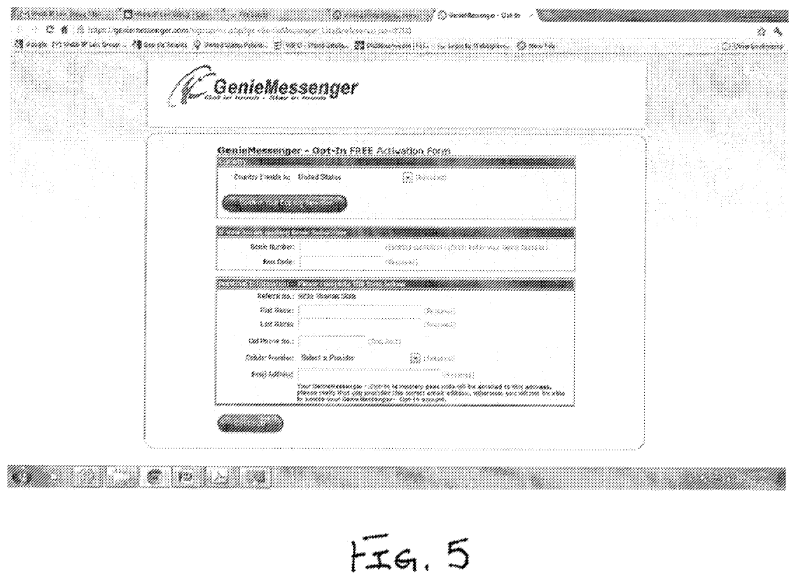

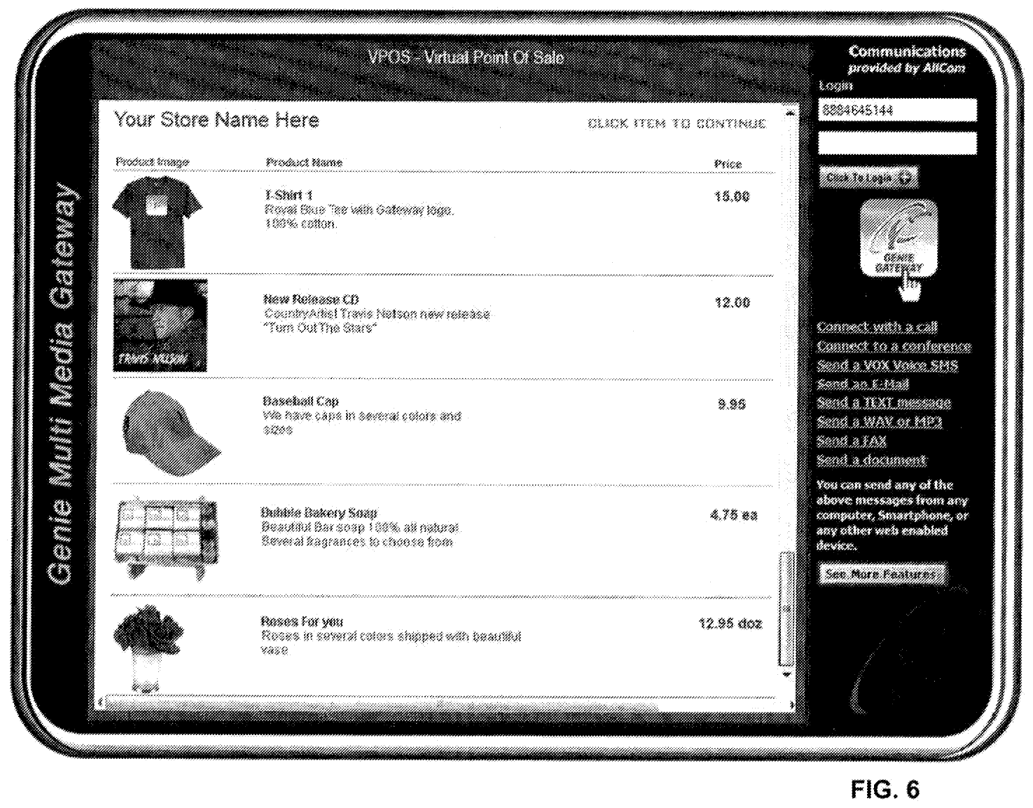

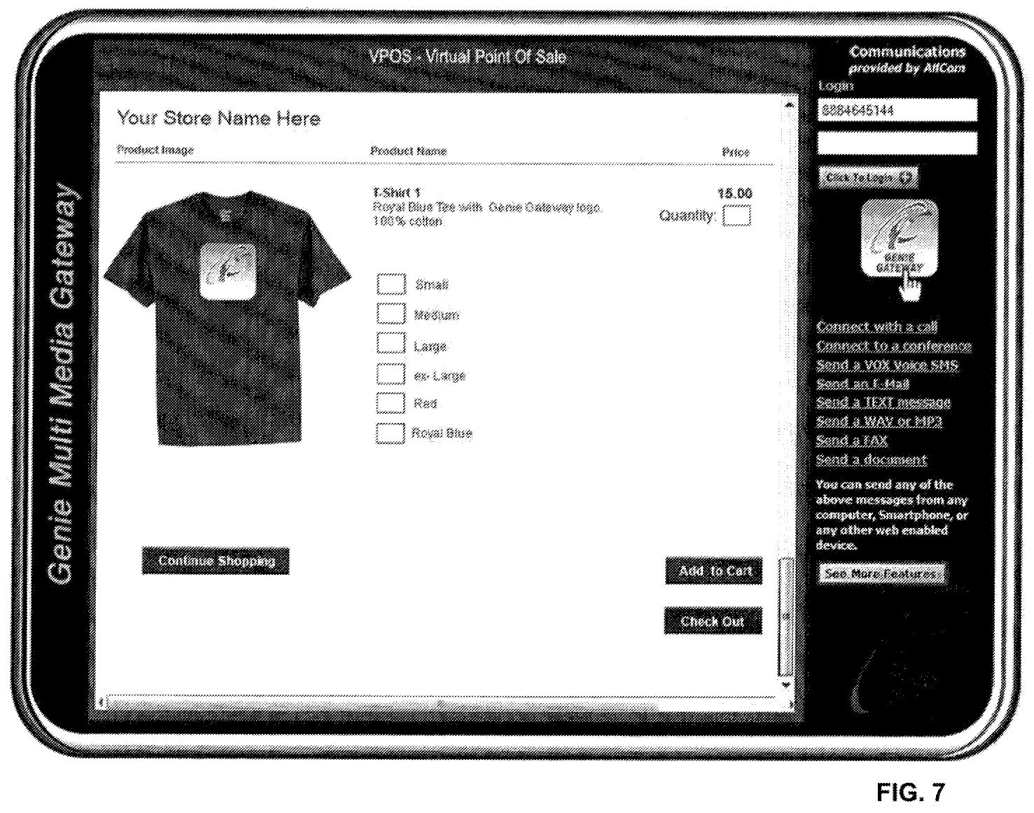

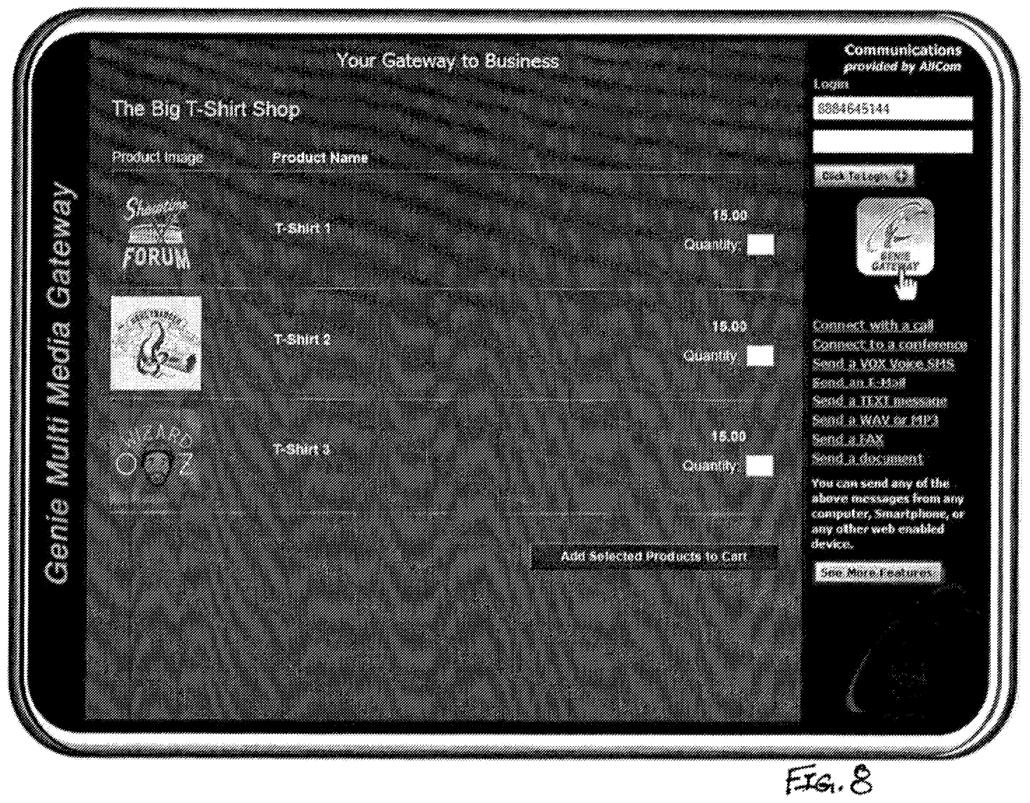

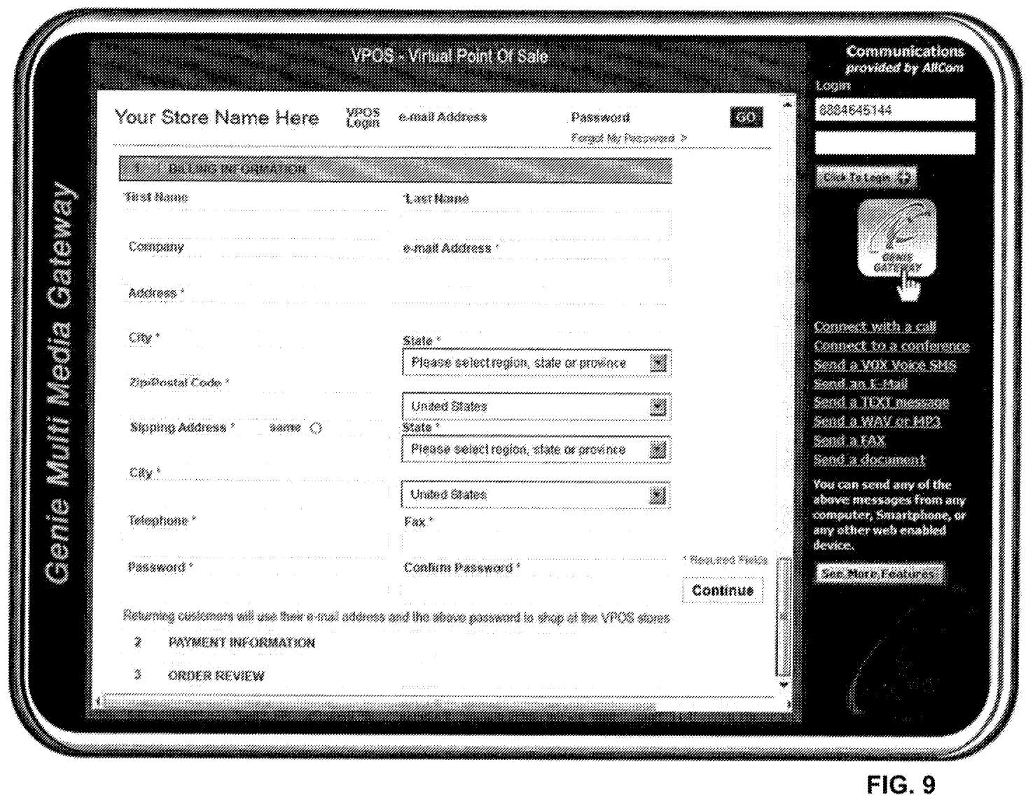

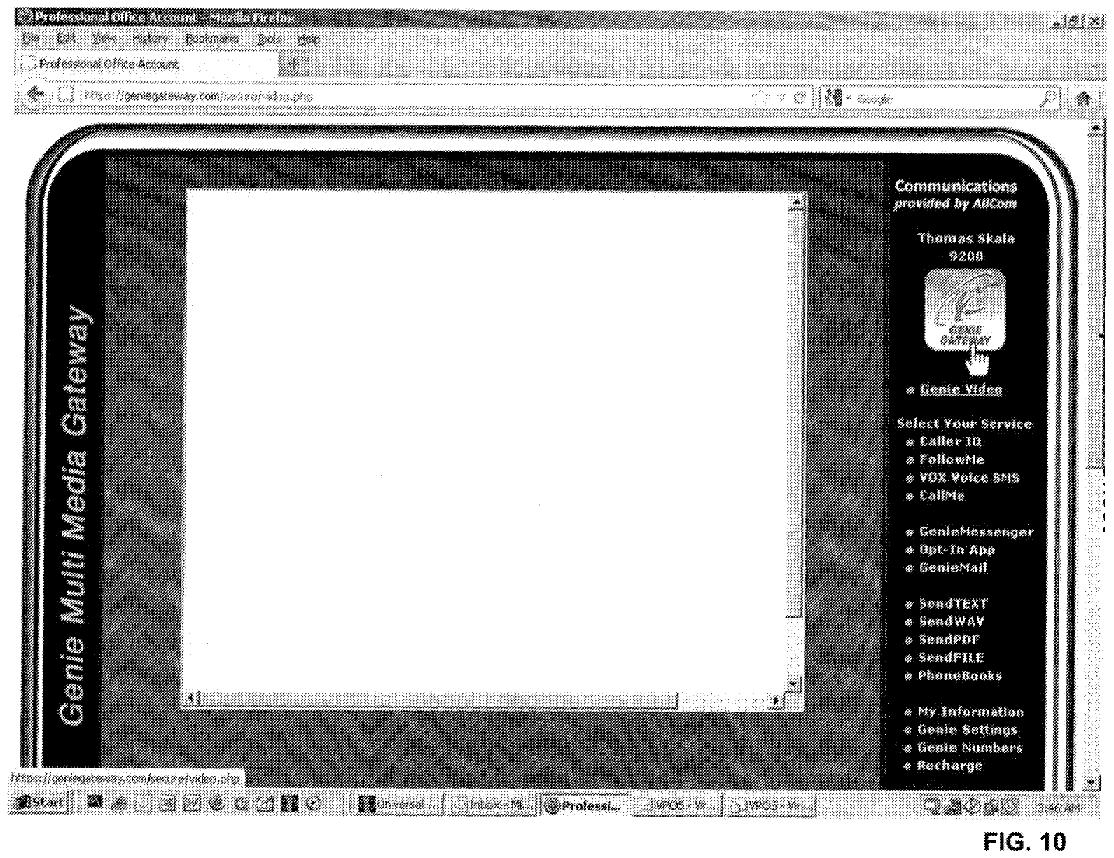

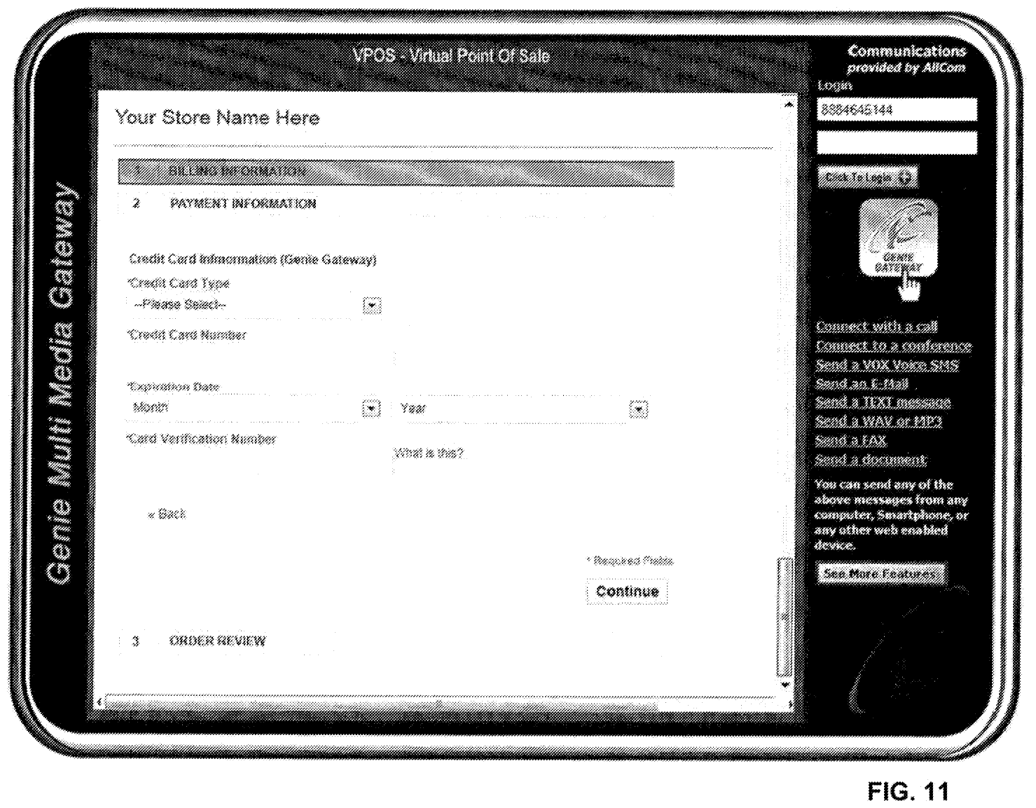

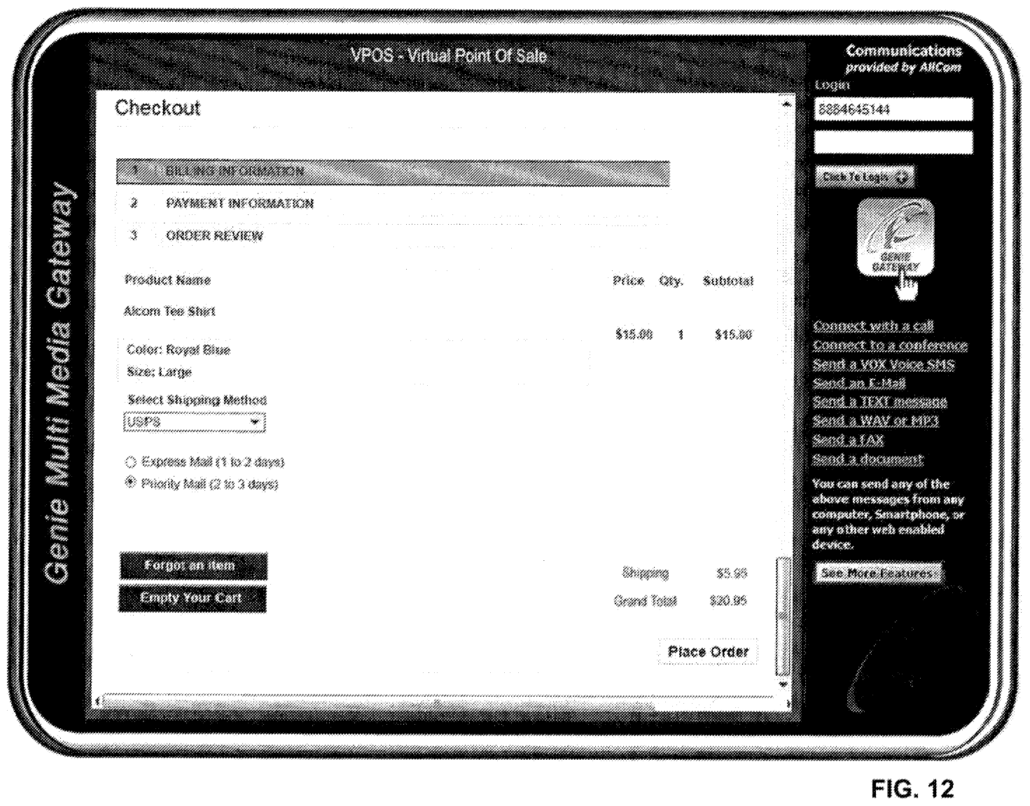

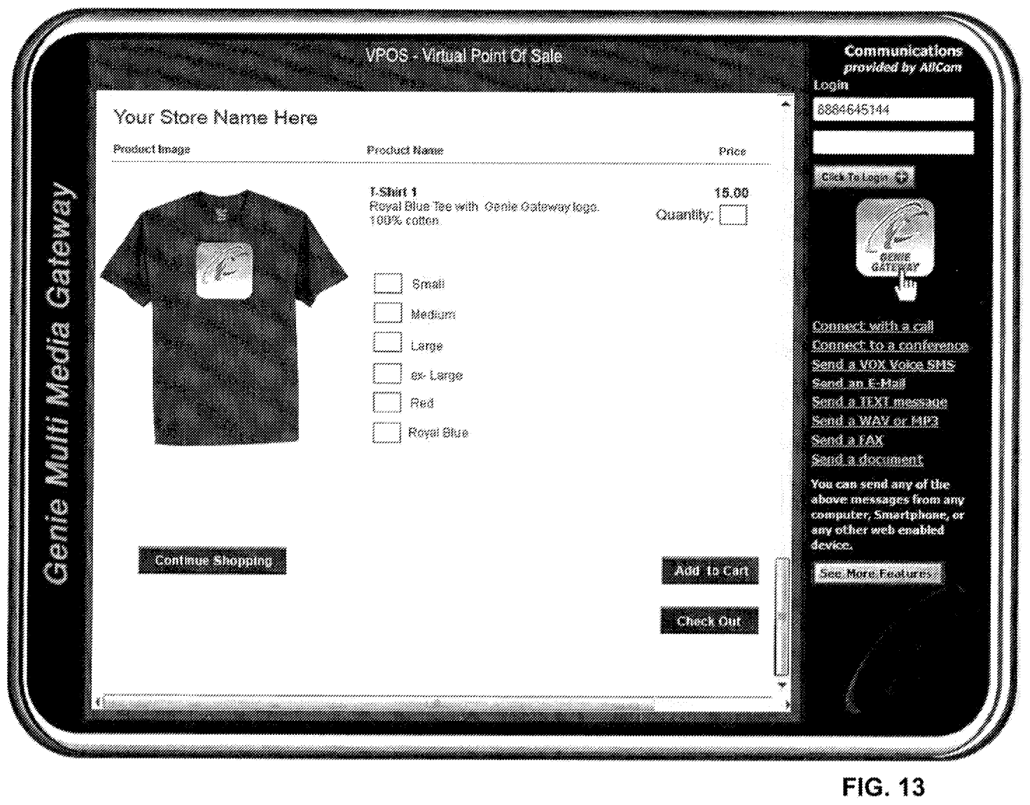

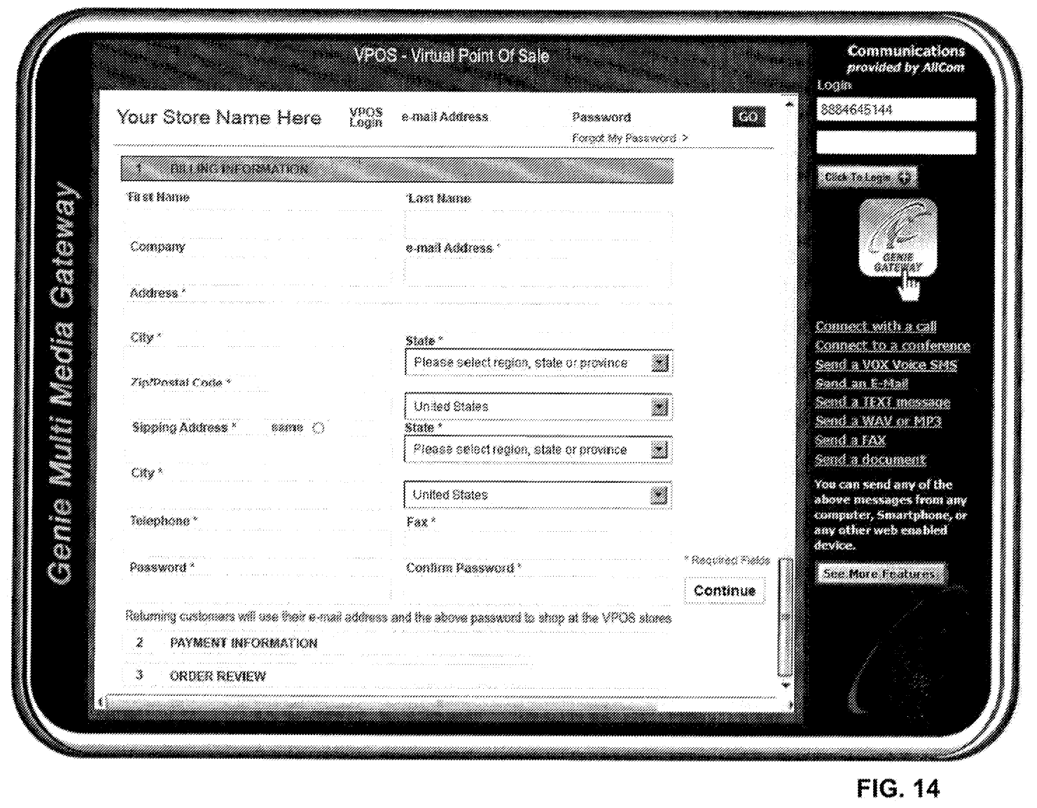

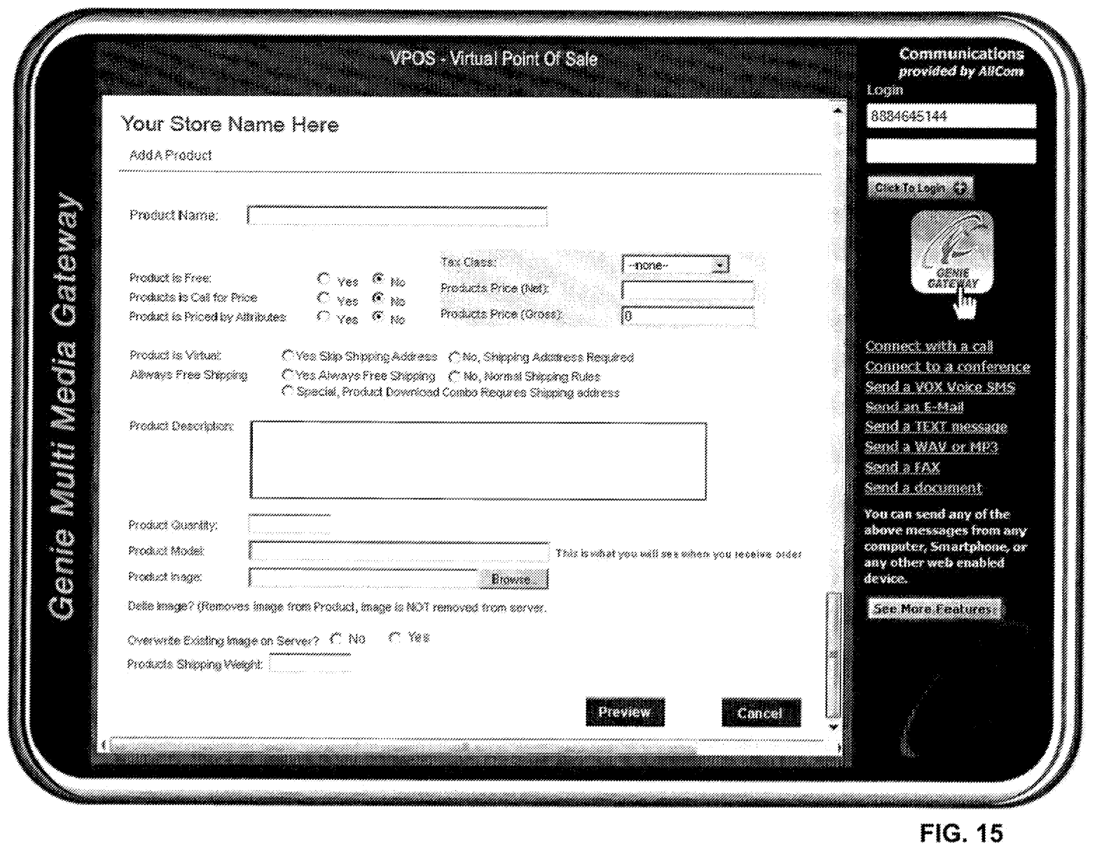

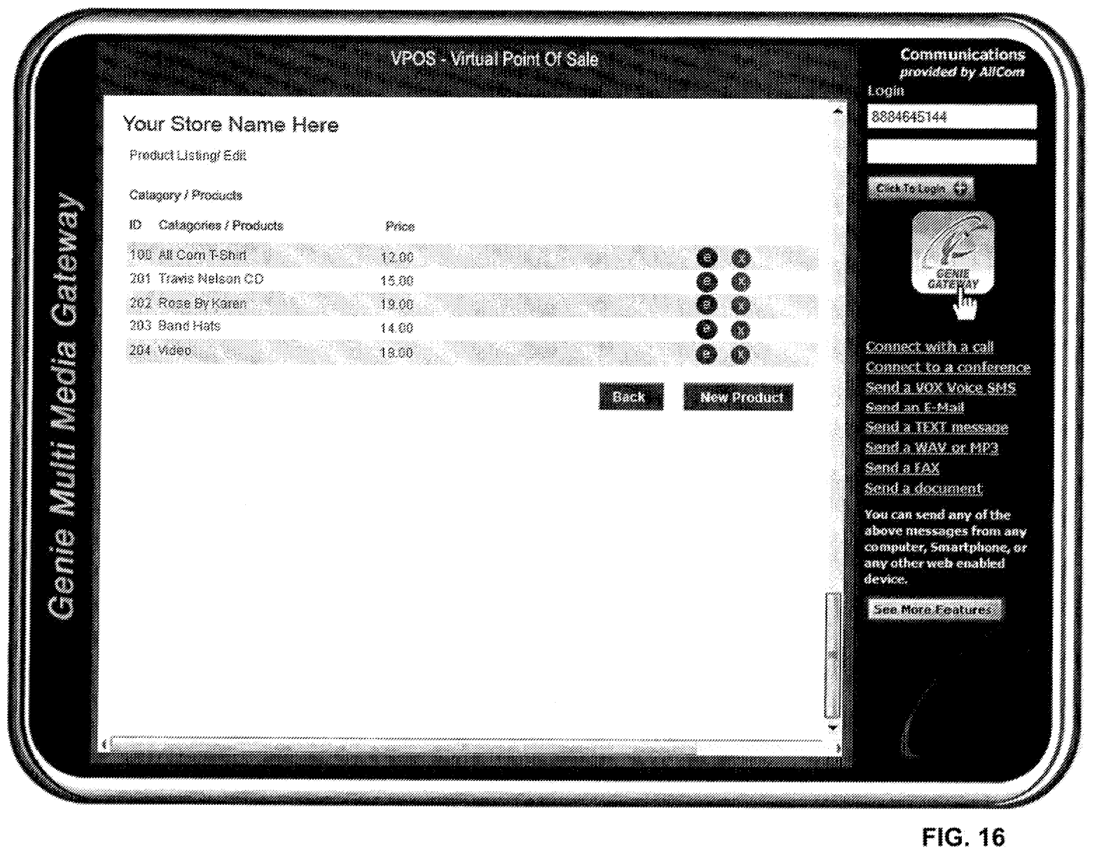

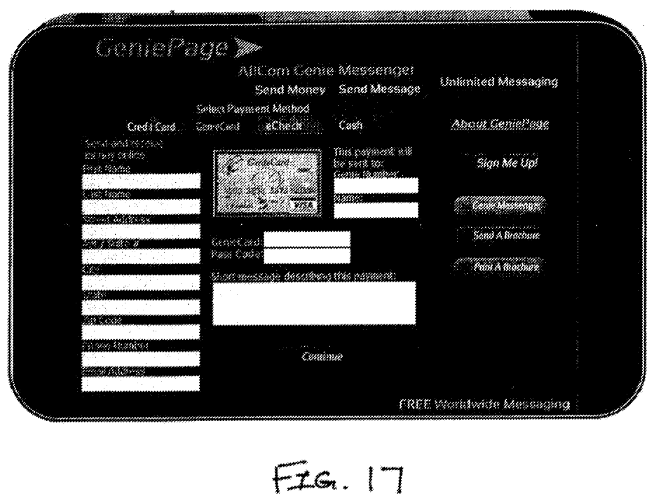

FIGS. 3-17 are exemplary/prophetic screenshots of the systems and methods described herein. The collection of screenshots includes input fields whose contents are intended to be filled in with appropriate context appropriate data by one or more of third party viewers and subscribers (account owners, users, etc.). The collection of screenshots also include hyperlinked text and images configured to cause activation of context appropriate modules.

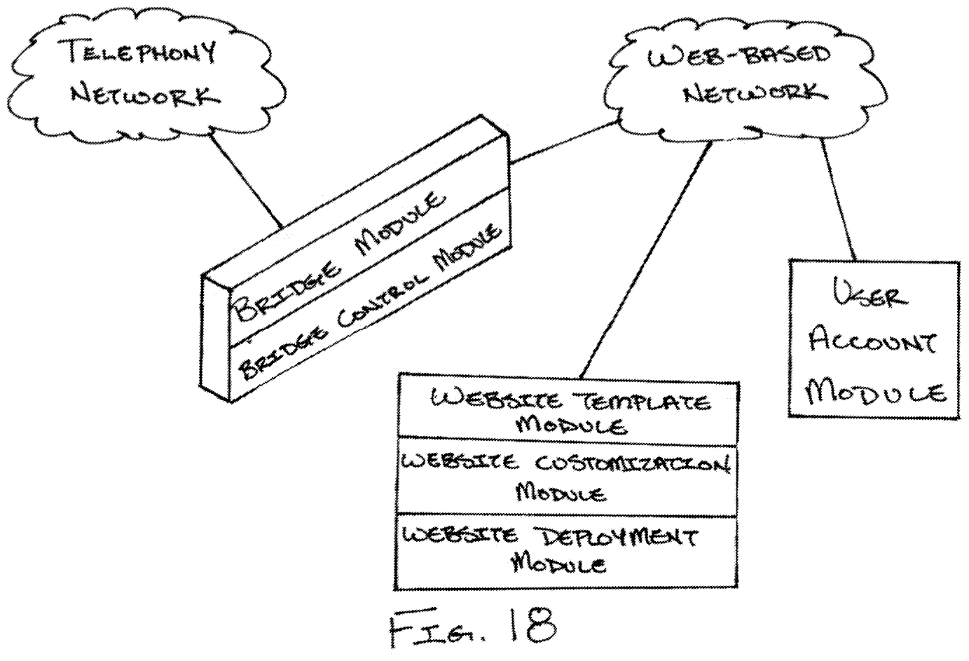

FIG. 18 illustrates a system according to one embodiment of the invention. In particular, there is shown an automated computerized website building system, that may include: an internet-telephony bridge module that may be configured to bridge network data and/or telephony data; a bridge control module that may be operatively coupled to the internet telephony bridge module and/or that may be configured to manage data transfer across the internet-telephony bridge; a user account module that may be in communication with the bridge control module and/or that may be configured to store account information of system users; a website template module that may be configured to provide a base website design that may be including both internet and telephony communication features; and/or a website customization module that may be in communication with the user account module the website template module and/or that may be configured to permit a user having a user account stored thereon to supply media information and/or user metadata for display and/or operation, respectively, on a website that may be built across the base website design of the website template module. One or more of the other modules described herein, named or otherwise, may be included in such a system.

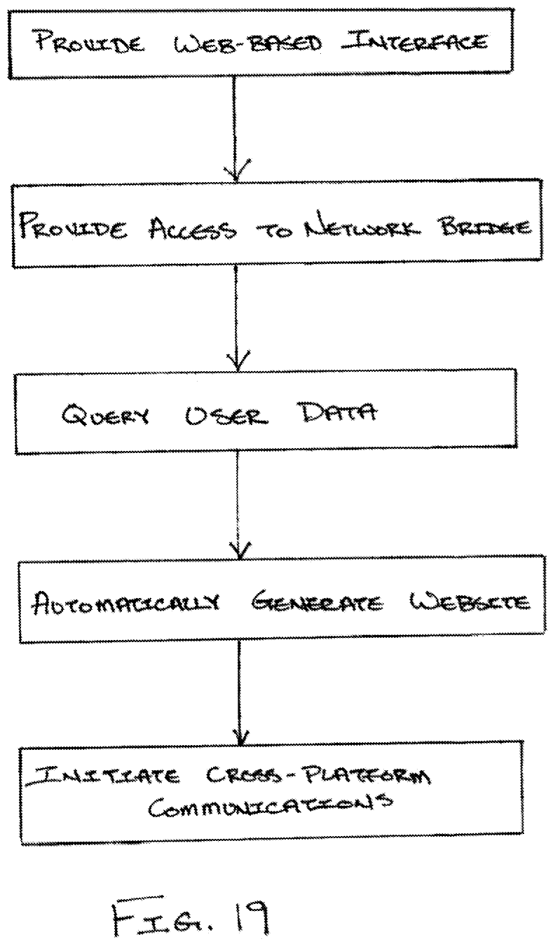

FIG. 19 illustrates a method according to one embodiment of the invention. In particular, there is shown a method of facilitating communications between web-based and telephony networks, that may include one or more of the steps of: providing a web-based interface that may include selectable options for initiating communications between one or more web-based communication tools and one or more telephony based communication tools; providing access to a network bridge that may be configured to bridge communications between a telephony network and a web-based network; automatically generating a web-based interface, in communication with the network bridge, from user account data for a user having telephony services; initiating a communication between a web-based network and a telephony based network on receipt of a request from the automatically generated web-based interface. One or more of the other function, actions, operations, and etc. described herein, named or otherwise, may be included in such a method.

The following is a non-limiting example of one embodiment of the invention. The features, functions, operations, steps, objects, devices, and the like and combinations thereof described therein may be embodied as one or more modules of a system and/or steps of a method. While the example uses the term “Genie Gateway” in a definitive sense, it is understood that other variations on the genie gateway are contemplated and that the following is merely exemplary.

### Exemplary Prophetic Example

The Genie Gateway—Genie Cloud and Softswitch

The Genie Gateway is a collection of technologies combining a variety of distributed clients, a centralized cloud and Softswitch (a module configured to pass data internally) which together integrate four powerful technologies: Telecommunications; Television; Internet and Electronic Banking into one seamless global service. Genie Gateway is an interactive communications hub featuring a suite of solutions which integrate:
a website (with search engine optimizations)
computers
telephones (landline or cellular; traditional or “smart”)
text messaging
GenieVOX Voice SMS
audio services
video services
email
fax services/virtual fax machines
television networks
document delivery
the Genie Gateway
a virtual office/unified communications
the Virtual Merchant
Opt-In web-smart phone applications

This elegant solution delivers all of these services from a single source on a single platform in a single cloud. An interesting approach in this is that information moves from process to process on the same platform, rather than from system to system—or even from provider to provider. This approach may deliver faster, more tightly integrated services with security, privacy, and/or safety, at a lower cost than any multi-platform competitors.

A purpose of the Genie Gateway is to expand the concept of communications—which traditionally involved simple telephone calls or text messages being delivered through a single entry point across a single medium to a single destination—to instead allow the communications to be more complex, be submitted through varying entry points, and be transmitted across multiple media to multiple destinations. Further, the Genie Gateway is designed to provide, send and receive this information with greater ease and lower costs, allowing for disruptive pricing.

A purpose of the Genie Gateway is to further expand the concept of a multi-media communications hub to provide additional business-to-business and business-to-consumer functionality. The Genie Gateway allows brief messages to be submitted through varying entry points, and transmitted across multiple media to multiple destinations, with the same in-channel response to the submitted messages.

When a visitor to a subscriber's Genie Gateway decides to make a purchase of goods or services, the transfer of funds to the subscriber may be accomplished from any third party, whether or not said third party is also a subscriber.

The Genie Gateway also incorporates a set of interesting mechanisms whereby the subscriber's customers can listen to audio presentations, watch video presentations and print brochures on any internet enabled computer. Subscribers may update their audio, video or downloadable text content generally at any time through a web interface. They may also update their audio content generally at any time via a telephone call.

Product Components

The Genie Gateway—Client

The Genie Gateway Client is a web—email—Smartphone—television web page/client, created by and for each individual subscriber through an interactive online process. Both the client and its creation process are aimed squarely at businesses and individuals who want a fully rounded presence in the multi-media world without the cost and complexity of the build-it-yourself approach.

Genie Gateway provides the benefits of a website and online multi-media web-presence, even if subscribers do not have their own website.

With a single click by a friend, family member or a business associate a Genie Gateway subscriber can receive a telephone message, a text message or an email (or all three) with a short text message to advise them that someone wants to contact them and why.

Subscribers can, at their option, call back, email, text or VOX their party, at their convenience. Generally, all aspects of the communication in both directions are handled directly through the single underlying platform.

Genie Gateway Clients are created by the subscribers online and each Client is automatically populated with subscriber information and then customized with the subscriber's name or business name, their marketing slogan, their audio files, their videos, brochures, their individual Opt-In App, their Genie Number, and other website (if any). The resulting configuration reflects what each subscriber chooses to share and display.

The following five points reflect how these features are explained to Genie Gateway subscribers. This material is intended to convey to the subscriber how the people to whom they are presenting themselves can use the Genie Gateway to get information about the subscriber's goods and services and how to use the communication features provided to both the subscriber and their customers. Modules are provided that facilitate and perform the listed functions/benefits.
Listen to your recorded messages: Now you can record your messages and updates from any phone, and all your visitors can click and listen to your updates anywhere, FREE of charge!
Read and print your brochures: Upload any Microsoft Office or Open Office documents from your computer. Your Genie Gateway will display a printable PDF document to all your visitors!
Watch your video: Upload a link to your video from your website, YouTube, or any other service provider!
Opt-in to receive your updates: Convert your visitors into potential customers in 2 seconds by inviting them to opt in for your updates!
The “one-click” way for anyone in the online world to reach you!: Your Genie Gateway is the absolutely INTERESTING web/email tool that links people to you, free of charge, from ANYWHERE in the world! The “one-click” way for any business or individual to be reached with Unified Messaging, Group Messaging, Voice & Emergency Messaging, Private & Social Network Messaging, without giving up their privacy, and more!

Genie Gateway subscribers receive the following capabilities and benefits. Modules are provided that facilitate and perform the listed functions/benefits.
Publish their recorded messages—Now they can record their messages and updates from any phone, and all their visitors can click and listen to your updates anywhere, FREE of charge!
Display their documents and brochures—Upload any Microsoft Office or Open Office documents from their computer. Their Genie Gateway will display a printable PDF document to all their visitors!
Show their videos—Upload a link to their video from their website, YouTube, or any other service provider!
Opt-in App for their updates—Convert their visitors into potential customers in seconds by inviting them to opt in for their updates!
The “one-click” way for anyone to reach them!—Their Genie Gateway is the absolutely INTERESTING web/email tool that links people to them, free of charge, from ANYWHERE in the world! The “one-click” way for any business or individual to be reached with Unified Messaging, Group Messaging, Voice & Emergency Messaging, Private & Social Network Messaging, without giving up their privacy, and more!
Click-to-Connect phone calls free worldwide—Visitors to their Genie Gateway can click on the Genie Number displayed and be connected from their web enabled device.
Send and Receive GenieVOX—GenieVOX (Voice SMS) is a business or service provider's interesting blending of the power of Voice Messaging with the ease and flexibility of Text Messaging. VOX allows subscribers to send and receive short SPOKEN message with one person or thousands, quickly and easily. Modules are provided that facilitate and perform the listed functions/benefits. When they get a VOX you can (through operation of one or more modules):
   Reply with a VOX of their own
   Reply with a telephone call
   Send the caller ID of the sender to voicemail, or
   Block the sender's caller ID from sending them future messages
   Send and Receive emails—Send and receive emails to and from their Genie Number.
   Send and Receive TEXT messages—Send a text message to Genie Numbers in their SendTEXT PhoneBook.
   Send and Receive WAV or MP3 files—Send an audio file to the E-Mail addresses and Genie Numbers in their SendWAV phonebook as an attachment.
   Send and Receive Faxes form any web enabled device—Send and receive any Microsoft Office or Open Office documents from any computer and any web enabled device. When faxes are received can be displayed as a printable PDF document.
   Send and Receive documents form any web enabled device—Send and receive any Microsoft Office or Open Office documents from any computer and any web enabled device. Genie Gateway will convert and display all documents regardless as to their original form to a printable PDF document.
   Dynamic Caller ID Greetings Genie Gateway captures the caller's ID (when available) from each call to provide subscribers with several one click features:
   Block unwanted callers anytime
   Accept or not to accept calls from a blocked callers IDs is generally their choice
   Record custom greetings, in any language, for any caller ID (for important customers or friends)
   Automatically send specific callers to voice mail so subscribers can call back at their convenience
   Automatic shortcut to hearing their messages when calling from their own phone, cell or landline
   Automatic shortcut to using Genie for their outbound calls (save money and keep your privacy) when calling from their own phone
   Follow Me—Change their FollowMe numbers and default greeting.
   Call Me—Program Genie to call subscribers immediately at a specified number (Call Back), reduce hotel phone charges and long distance charges.
   Genie Gateway—The “One-Click” way to receive messages from anywhere free, create as many FREE Genie Gateways as they need with a hyperlink showing their name or business name and Genie Number.
   Opt-In App—Invite subscriber's friends and customers to receive their updates free. Create an Opt-In App which includes special codes that allow someone to click on it and instantly be added to their PhoneBooks.
   SendFILE—Send a file to the E-Mail addresses and Genie Numbers in your SendFILE phonebook as an attachment.
   GenieMail—View and retrieve their emails, voice mails, faxes, and pages online. Use as regular email. E.g. Subscriber's Genie email address is 9991230000@geniemail.com
   Your GenieMail format is 8001234567@GenieMail.com
   Phone Books—Manage all their PhoneBooks.

A Genie Gateway Button is a personalized HTML client icon that may be embedded in a subscriber's email messages, on their website, in electronic documents and brochures, in content on social media sites, or in any location where an HTML document may be displayed. When an interested party clicks on the Genie Gateway Button, they are taken to the Genie Gateway associated with the subscriber's Genie Number.

Sample of default Genie Gateway Buttons. Subscribers can also create their own custom Genie Gateway Buttons.

Message content of material submitted through a Genie Gateway is generally identical to that submitted through the GenieMessenger. The message submission process of material submitted through Genie Gateway is generally identical to that of material submitted through the GenieMessenger. The message delivery process of material submitted through a Genie Gateway is generally identical to that of material submitted through the GenieMessenger. Messages submitted through the Genie Gateway have the same properties of simultaneity as those submitted through the GenieMessenger. Messages submitted through the Genie Gateway receive the same confirmation handling as those submitted through the GenieMessenger. Subscribers may respond to messages submitted through the Genie Gateway in all the same manners as those submitted through the GenieMessenger. The Genie Gateway web interface allows a subscriber to easily present web visitors with several different forms of audio, visual, printed or otherwise downloadable information.

Each Genie Gateway includes the capacity for the subscriber to record and visitors to playback an audio recording of up to 5 minutes in duration. The intent is to give the subscriber a method to describe their business, or to present any other audio information relevant to their activity.

A key concept is the ability of the subscriber to rapidly and easily change the content of these audio recordings. The recording may be changed by the subscriber generally at any time by calling their Genie Number from any ordinary telephone, signing in to their account and selecting the appropriate options from a spoken menu.

Additionally, a subscriber may choose to prepare their audio content on any other system they choose, and then upload the audio file they have created through their Genie Gateway web interface. Anticipated uses would include such things as commercial messages explaining a business's capabilities, announcements of special sales and promotions, inspirational messages from religious organizations, activity announcements from social or political groups, etc.

Each Genie Gateway includes the capacity for the subscriber to upload and visitors to download and/or print a text document of up to 100 pages. The intent is to give the subscriber a method to present written material describing their business, or to present any other text information relevant to their products and activity. Subscribers can prepare their document in almost any format, Open Office, Microsoft Office, and many other types of documents, which the Genie Gateway will automatically convert and upload as a PDF file to the subscriber's Genie Gateway so that it could be viewed online by all internet enabled devices.

Anticipated uses would include product brochures, order forms, survey documents, political campaign literature, inspirational messages, self-help literature, etc.

Each Genie Gateway includes the capacity for the subscriber to upload and visitors to playback a video presentation of up to 3 minutes. The intent is to give the subscriber a method to present visual material describing their business, or to present any other video information relevant to their activity. In addition, subscribers can also upload a URL to their video hosted on YouTube or any other service provider with the advantage of allowing their visitors to watch their videos without leaving their Genie Gateway. Subscribers would prepare their video on whatever system they choose capable of producing a avi, flv, mov, mpg, rm, swf, wmv file format, and then upload the file through their Genie Gateway web interface. Anticipated uses would include displays of products, visual tours of rental or sale properties, demonstrations of past projects, etc.

The Opt-In feature allows the web visitor to enter his or her own contact information in such a form that the subscriber can then transmit information outward to the visitor immediately or at a later date. Information entered by the web visitor includes (but is not limited to):
Name
Telephone Number
Cellular number
Genie Number (if the visitor is also a subscriber to one or more Genie services)
Email address

This information is appended as appropriate to various PhoneBook lists (described below) in the subscriber's underlying Universal Office. Those PhoneBooks then allow the subscriber to transmit to large numbers of persons (all of whom have “Opted In” in similar fashion) such things as:
Text Messages
GenieVOX Messages
Email Messages
Documents
Audio and Voice Messages
Videos

Anticipated uses would include advertising material, special product announcements, regional safety information, organizational updates, political information, religious or other affiliated group content, etc.. It is important to note that generally all such information is thus sent only to persons who have actively elected to receive it.

In addition to the presentation capabilities described above, the Genie Gateway also provides web visitors with a number of options for sending information to or otherwise communicating with the subscriber.

The web visitor can initiate a voice call with the subscriber. The web visitor will be presented with two options:
Call Back—The visitor will enter a telephone number and other identifying information. The system will initiate a telephone call to the visitor at the indicated phone number, and immediately connect that phone call to the Universal Office (described below) belonging to the subscriber. The visiting caller is then able to use the features of the Universal Office to connect to the subscriber, leave a message, etc.
Web Call—If the web visitor is accessing the Genie Gateway from an audio-enabled web device (such as a computer with headset or speakers and microphone, tablet device or a smartphone), the visitor's web session may be connected directly to the subscriber's Universal Office, using Voice Over IP communication, free of charge from anywhere worldwide. Name, telephone number and other identifying information is still gathered for record-keeping purposes.

The web visitor may request a connection from his or her audio-enabled web device (such as a computer with headset or speakers and microphone, tablet device or a smartphone) directly to the Conference feature of the subscriber's Universal Office. The web visitor can then participate in an audio conference with the subscriber and others, without regard to whether the other participants are using any mixture of telephones, web devices or any other future supported technologies.

The web visitor may select to send a GenieVOX (described in more detail below). The visitor will be presented with two options:
Call Back—As described above, the visitor will enter phone and other information, receive a telephone call from the system, and be allowed to record a GenieVOX message, to which the subscriber may respond by:
   Return VOX
   Return Phone Call
   Pass to Voice Mail
   Block future VOX's from the caller
Web Call—As described above, if the web visitor is accessing the Genie Gateway from an audio-enabled web device the visitor's web session may be allowed to record a GenieVOX message, to which the subscriber may respond by:
   Return VOX
   Return Web Call
   Pass to Voice Mail
Name, telephone number and other identifying information is still gathered for record-keeping purposes.

The web visitor may enter name, email address, other identifying information and a brief email message, which will be sent to the subscriber's Genie Number. It is important to note that the subscriber's actual email address is not exposed to the web visitor or to web information harvesting tools.

The web visitor may enter name, email address, other identifying information and a brief text message, which will be sent to the subscriber's cellular telephone and/or email account, at the subscriber's option. It is important to note that neither the subscriber's actual cellular phone number nor email address is exposed to the web visitor or to web information harvesting tools.

The web visitor may upload a short audio recording in a WAV or MP3 format. If the web visitor is accessing the Genie Gateway from an audio-enabled web device the visitor may also optionally record a message directly through the web interface.

The resulting uploaded or recorded message will be delivered to the subscriber either in an attachment to an email message, or as a voice mail recording, at the subscriber's option. As with similar features herein, the subscriber's actual email address and/or phone information is generally never exposed.

The web visitor may upload a document in numerous formats including but not limited to Microsoft Office documents (Word, Excel, etc.), equivalent Open Office documents, or images such as JPG, GF, TIFF, PDF, etc. The system will convert the uploaded document into PDF format and deliver the resultant PDF to the subscriber as an email attachment, an/or send the output to a FAX machine designated by the subscriber. It is important to note that neither the subscriber's actual FAX phone number nor email address is exposed to the web visitor or to web information harvesting tools. The web visitor may upload any combination of 5 document in numerous formats including but not limited to Microsoft Office documents (Word, Excel, etc.), equivalent Open Office documents, or images such as JPG, GIF, TIFF, PDF, etc. The system will convert the uploaded document into PDF format and deliver the resultant PDF to the subscriber as an email attachment. As with similar features herein the subscriber's actual email address is generally never exposed to the web visitor or to web information harvesting tools.

The web visitor may enter information to remit funds from their own Genie account to the subscriber for any of a variety of purposes. Anticipated uses include merchandise sales, charitable donations, political contributions, etc. The fund remittance features are described in greater detail under “Financial Services” below.

The web visitor may view and purchase goods and services that the subscriber offers for sale. The web interface will display images, descriptions and prices of items, as uploaded and entered by the subscriber. Purchases may be completed by use of several major credit cards, or by use of funds in the web visitor's own Genie account, if they are also a subscriber. The fund remittance features are described in greater detail under “Financial Services” below.

The Genie Gateway Client is a web interface, generated and hosted specifically for each subscriber, to link anyone in the online world with One-Click to subscribers and to their individual audio and/or visual information. The Genie Gateway is tightly integrated with the GenieMessenger interface.

The GenieMessenger product is a unified system for exchanging short messages from business-to-business, business-to-consumer or consumer-to-consumer, across several communications media simultaneously. Additionally, the system includes the capacity to remit money from any person to a given service subscriber.

The messages handled by the GenieMessenger service generally contain the following information:
Genie Number1—The interesting telephone number assigned to the subscriber for whom the message is intended ¹See below for a more detailed explanation of the Genie Number invention.
Sender's Call-Back Number—The phone number at which the message sender can be reached
Sender's Name—The sender's name in text or as a recording (see Message Submission—Telephone, below)
Sender's Email Address—The email address at which the message sender can be reached
Brief Text Message—A short text message of 140 characters or fewer
Urgency Flag—a Yes/No selection as to whether the message is urgent

A consumer submits a message to the GenieMessenger service through any of three paths. The only information the message sender needs is the Genie Number of the subscribing customer to whom the message is directed. (See ‘Genie Gateway’ for an exception)
Telephone—The message sender can directly call the Genie Number for the recipient. From a spoken menu of options, they can select the option to Page the subscriber. When submitting a page by telephone, the sender is asked to record their name (rather than enter it as text), and is also allowed to mark a paging message as urgent. No email or text message information is gathered.
Web Site—The message sender can use an Internet web browser to go to the website www.GenieMessanger.com. There, they enter all six of the key message elements listed in Message Content, above. They then select the Send Message option to submit the message.
GenieMessenger—Service subscribers have an option to create a personalized icon, called the GenieMessenger, which encapsulates their own Genie Number and their name into a graphic element which they can then add to their email messages, websites, etc. A message sender can then click on this personalized icon to start the message submission process. They are taken to the same basic web interface described above, except that the Genie Number of the intended recipient is pre-populated. Thus, the sender does not need to know either the Genie Number of the recipient, nor the web address of the submission site.

The submitted message is delivered to any or all of the following targets. Which target or targets receive the message is at the discretion of the service subscriber, and may generally be reconfigured generally at any time.
Pager—If the subscriber has registered a traditional pager, they receive the sender's callback number through that device.
Email—If the subscriber has registered an email address with their service, they receive an email with the details of the page. In the case of a telephone submission, the message includes the date/time, the callback number entered and a copy of the recorded caller name. In the case of a Web or GenieMessenger submission, the message includes the date/time, and all six of the Message Content items listed above.
Voice Notification—If the subscriber has registered a notification number (from 1 to 3 numbers may be registered), they receive a phone call alerting them to the callback request. The phone message contains the date/time of the message and the callback number. In the case of a telephone submission, it also includes the recorded name of the sender.
Cellular SMS Message—If the subscriber has registered an SMS capable cellular number, they receive a text message on that device. In the case of a Web or GenieMessenger submission, the message contains the date/time, and all six of the Message Content items listed above. No SMS Message is currently generated by a Telephone submission.
Web Interface—Generally at any time, the subscriber may log in to a separate web interface provided as part of their subscription, and retrieve GenieMessenger messages in the form of a web-based version of the E-Mail notification described above.

GenieMessenger messages are generally delivered to the subscriber through all of the relevant pathways at the same time. Which method or methods will be used is at the sole discretion of the subscriber, based entirely on which pathways they have registered in their service setup. These options may be changed by the subscriber generally at any time, to suit their individual needs.

In the case of a Web or GenieMessenger submission, the sender receives an email message confirming their submission, including the date/time of the submission, and all six of the Message Content items listed above. The confirmation message does not generally include information on which delivery path or paths were used to deliver the message to the subscriber.

The subscriber may respond to the message immediately, in any of several means, depending on the path through which they receive the message.
Pager—The subscriber would return the call through any ordinary telephone of their choosing, or by calling in to their service number.
Email—The subscriber may respond to the sender's email address embedded in the message, or note and use the telephone number as with a traditional pager message.
Voice Notification—The subscriber may press a single key on their telephone keypad to place a return call to the caller's number.
Cellular SMS Message—The subscriber may use the SMS features of their cell phone to reply to the embedded email address of the sender, or to reply to the embedded phone number of the sender.
Web Interface—As with a direct email message, the subscriber may respond to the sender's email address embedded in the message, or note and use the telephone number as with a traditional pager message.

Each Genie Gateway account may include, if the subscriber chooses, an instrument called the GenieCard. The GenieCard is a stored-value, reloadable debit card, carrying a major debit card issuer logo, and serviced through the same banking channels as all other major debit cards.
Transfer Interface—All financial transfers are initiated using the web interface. The appropriate interface is generally only available through the use of the Genie Gateway (described above under Message Submission).
Transfer Target Generally all financial transfers made through the Genie Gateway system are made to the GenieCard of the receiving subscriber.
Transfer Sources—The third party using the Genie Gateway system to send money to a subscriber may choose among four sources from which to submit the funds:
Credit Card—The sender may charge the desired amount to a credit card. Accepted cards include Visa, MasterCard, American Express, Discover and Diners Club. Credit Card transactions are confirmed immediately with the source issuer, and are credited to the recipient's GenieCard after 72 hours.
GenieCard—If the sender is also a subscriber to the GenieCard system (which may be as a Genie Gateway subscriber, or as a subscriber to several other of a business or service provider's product packages), they may transfer the money from their own GenieCard to that of the recipient. GenieCard to GenieCard transfers are processed in real time, with the funds being immediately withdrawn from the source account and made available in the recipient account.
eCheck—The sender may elect to have the funds withdrawn electronically from a checking account. In this case, the sender will need to provide the routing and account information from their checking account. eChecks are processed through the Automated Clearing House (ACH) system, and require two business days to complete and be credited to the recipient account.
Cash Deposit—Finally, the sender may wish to provide cash as the method of payment. In this case, the sender will be asked to select from a list of financial institutions that are partnered with a business or service provider. The system will then prepare a deposit slip for the transaction, including all the routing information required to transfer the funds to the GenieCard account of the intended recipient. The sender then takes the deposit slip and cash funds to the selected financial institution as a regular deposit transaction. Cash deposits are processed to the recipient GenieCard account two business days after receipt. This method may not generally be used with any medium other than cash. Generally, no credit card, check, money order or other instrument will be accepted.
Funds Use—Funds thus received are available to the subscriber in the time frame as indicated above. Funds may be accessed as a cash withdrawal at any Debit-capable ATM worldwide, by making a debit purchase at the location or web site of any merchant accepting Major-logo debit cards.
Transfer Notification—The sender receives an email notification of the transfer, just as they would receive notification of a text message. The recipient receives similar notification of the transfer by email and text message.

As described in “Funds Transfers” above, each Genie Gateway account may include, if the subscriber chooses, a stored-value instrument called the GenieCard. Subscribers to the GenieCard have use of two additional, related services for carrying on sales and other related activities.
Virtual Merchant—The Virtual Merchant is a sales tool connected to the subscriber's Genie Account through the telephone interface. Callers to the subscriber's Genie Number can press a key on their touch-tone keypad, and then follow spoken prompts to enter a dollar amount, their credit card information, and a recorded message describing what the funds are for. The system will process a transaction against the caller's credit card, deposit the funds into the subscriber's GenieCard account, and send a copy of the recorded message along with a description of the amount remitted, as well as details of the caller's phone number to one or more email addresses designated by the subscriber. Up to three email addresses can be specified in the current implementation. The subscriber is then able to fulfill the caller's request appropriately by shipping merchandise, or taking other actions as indicated.
Virtual Point-of-Sales (VPOS)—The VPOS function extends the concepts of the Virtual Merchant to the Genie Gateway web interface. The subscriber is able to enter a series of item descriptions and pricing information, along with uploaded images showing the product or products described. Visitors to the web site are then able to view the images, descriptions and prices, from which they can select one or more item(s) to purchase. Upon selecting an item or items, they are then prompted to enter credit card information as well as shipping location details. Upon completion of the transaction by the visitor, the system will process a transaction against the visitor's credit card, deposit the funds into the subscriber's GenieCard account, and send a description of the purchase, the amount remitted, and other details entered by the visitor to one or more email addresses designated by the subscriber. Up to three email addresses can be specified in the current implementation. The subscriber is then able to fulfill the visitor's purchase request appropriately by shipping merchandise, or taking other actions as indicated.
Credit Card vs. Genie Account Remittances—The Virtual Merchant and VPOS functions will each accept both Credit Card and Genie Account sources as valid methods of remittance. One key difference is that, in the case of Genie Account remittance, all transactions remain entirely on the system platform. As a result, these transactions occur in real time, with immediate funds availability to the subscriber. In contrast, credit card transaction generally must be verified against the card provider's authorization systems. As a result, credit card transactions are subject to both practical and regulatory delays and limitations.

A non-limiting list of exemplary benefits that may be experienced using a genie gateway include:
Ease of Use—The sender needs only a minimal amount of information to be able to reach the subscriber.
Flexibility—The subscriber may generally at any time alter or adjust the methods of delivery to suit their needs, without having to notify potential senders of any background changes, such as changed phone numbers, travel and availability
Redundancy—The sender and subscriber can both be assured that multiple delivery paths will be used whenever available, thus reducing or eliminating the likelihood of delivery failure and missed messages.
Privacy—The subscriber does not need to disclose private details to the sender, such as personal cell phone or pager numbers, email address, etc.
Traceability—Both the sender and the subscriber receive sufficient information to determine the actual date, time, and content of the message, thus reducing or eliminating the possibility of misunderstandings as to the course of the message exchange.
Responsiveness—The subscriber is able to respond in any of several ways, at their complete discretion.

By combining multiple methods of submission and delivery into a single system, Genie Gateway provides a system for delivering and responding to short messages traditionally handled by much more limited paging and notification systems.

It is desired to enable subscribers to create and activate their Genie Gateway on their own, anytime by simply typing their name, and a few other details. A key is simplicity, full automation, and/or self-service.

The Genie Gateway is about communications with privacy, security, safety and economy. Individuals who are tired of living in a glass house where their personal information such as their home phone, work phone, cell phone, email address, telephone call records, emails, or search habits are subject to intrusive data mining for profit, by parties with ulterior motives—from using this information for advertising the goods and services of third parties to identity theft and other frauds—can utilize the Genie Gateway as their personal gateway and buffer.

Genie Gateway Clients do not generally contain any of a subscriber's confidential information. Thus they are safe to distribute via email, electronic brochures, or displayed on websites and smart cell phones as an application. The personal information of the subscribers is stored on the password protected secure Universal Office Softswitch (“Softswitch”) so that the private telephone numbers, the geographical locations or the email addresses of the subscribers are not revealed unless the subscriber wishes to do so.

The Genie Number is a generally unique “digital identity” for subscriber's to use as a passport to personal privacy and security in a world where, telecommunications, the Internet, and electronic banking are seamlessly integrated into one interesting number the International Genie Number. Genie Numbers are the Gateway to the Genie Cloud used by Subscribers and their callers to communicate and send and receive calls, messages and transaction from each other. In addition to the International Genie Number a business or service provider also provides its Subscribers with a Local Genie Number and a Toll-Free Genie Number, a business or service provider offers Subscribers three types of Genie Numbers:
Local Genie Numbers
Toll-Free Genie Numbers
International Genie Numbers

Genie Numbers are virtual telephone numbers, hosted on the Softswitch, and do not reflect any information about the Subscriber's personal telephone numbers, telephone calls, or their geography. Subscribers can utilize a business or service provider's FollowMe service to receive their telephone calls, messages, faxes and paging anywhere, anytime on any telephone, without revealing their private information unless they choose to.

When returning calls through the Softswitch the caller ID shown to the call recipient can be configured (regardless what telephone is used to return the call) to display: the subscriber's Genie Number; a general system number for those subscribers who desire more privacy; or any telephone number selected by the subscriber.

a business or service provider developed the software which enables it to host, manage and activate of both toll-free and local telephone numbers from telephone companies providing service in thousands of cities around the world.

Genie subscribers can establish local presence in any market where Genie Numbers are available, without needing their own physically local office and without long distance or international telephone charges.

A subscriber in San Francisco can easily activate a local Genie Number in Chicago, New York, London or Paris, which ring in their office, home or on their cell phone in San Francisco without long distance or international charges and without the need to order that service from the telephone companies in the originating cities. Genie Numbers can be used to:
Receive telephone calls.
Make telephone calls.
Receive messages.
Send and receive emails.
Receive faxes.
Receive pages.
Host conferences.
Process merchant transactions.
Send and receive money

GenieMail is an all in one communication center which for privacy reasons utilizes a numbered account concept (subscriber's Genie Number) in lieu of their name in the email address. GenieMail is a web-based, hosted email service tightly integrated with voicemail, SMS messaging, FaxMail and TelePaging. GenieMail enables subscribers to send, view and retrieve their emails, manage their voicemail, faxes, and pages online from any internet enabled computer.

In keeping with the self-service business model, GenieMail accounts can be created by subscribers online, free of charge, anytime, a business or service provider's business model generally does not include selling advertising or information to third parties and thus has no built in conflict-of-interest which would lead to data mining emails and the habits of its subscribers.

The interesting embodiment in GenieMail is the Unified Inbox which integrates and synchronizes with business or service provider's voicemail, FaxMail, paging and messaging services. When logging in, subscribers will use GenieMail's Unified Inbox to navigate through all their messaging needs. Please see below:
You have:
11 Unheard Voicemails messages
4 Unseen Faxes
0 Unseen Pages
9 Unread Emails
Check Messages Online

Genie subscribers can utilize their Genie Number as their email address (for example 8004567890@tGenieMail.com) or select an alias (for example GenieSubscriber@; GenieMail.com). Aliases can be created through the Alias Manager and are aliases to the primary email address, which generally utilizes the Genie Number.

GenieMail supports both the POP3 and IMAP protocols. The difference is POP3 messages are downloaded directly to, and managed on the subscriber's local computer. IMAP keeps all messages on the Softswitch and allows subscribers to manage them there. Therefore an IMAP client will mimic the folder structure displayed on the GenieMail website, and look the same on all computers used.

Genie SMS is an application created to enable a business or service provider to send emails that simulate text messages. The public is familiar with sending text messages from cell phone to cell phone as well as sending emails from various web enabled devices. Sending emails is almost generally free as they are sent via the internet while sending text messages is not free as they are sent on the telephone network.

The public does not commonly know how to send emails to cellular telephone numbers because each cellular provider has a different protocol to receive emails and their customers do not know these protocols. Cellular providers do not usually publish this information as they prefer text message usage thus generating revenues instead of the free email service.

A business or service provider's embodiment is the combination of a database of all the protocols of cellular companies worldwide with a user interface in which subscribers only need to select a country, enter the cellular number, and select the cellular provider for that number, a business or service provider's Softswitch then matches their message with the appropriate cellular provider's protocol and sends an email in a text message format.

This program enables users to enter messages of up to 140 characters, on any internet connected device with a keyboard, then packages that message in a text message format but delivers it as an email to the selected cellular provider. The end result is that the recipient receives a message that looks like a text message but is charged for receiving an email—usually a lower priced or non-charged event.

Genie-to-Genie text messaging utilizes the Genie SMS embodiment but is designed to utilize a Genie Gateway Application, downloadable to all smart phones, tablets, personal computers and other internet connected devices.

This system will interestingly contain the specific requirements of each device hosting such Applications and will communicate over the internet directly with the Universal Office Platform where all the required protocols and the private user information will be maintained. Each application will be branded with a generally unique Genie Number embedded as the “send and receive identification number” instead of the commonly used cell phone numbers of the sending or the receiving device. Genie-to-Genie Text Messaging will not use the sender's private cell or land line phone numbers or an email address to identify the sending or the receiving device and all such private information will be maintained under the direct control of each Genie Subscriber in their password protected account on the Universal Office Platform. The application will provide senders with the ability to send either a text message or a VOX—Voice SMS to a single Genie Number or select one or all the Genie Numbers contained in their SendTEXT PhoneBook with a single command. Genie Subscribers will be able to send a text message from any internet enabled device with a keyboard. The “Sender's Address” will generally be their Name and Genie Number regardless of which device they use to send their message.

The Application hosted on the receiving subscriber device will display the text, as well as store it locally on the receiving device, and play the audio VOX SMS allowing the receiving Subscriber to simply reply with one click. To insure that text messages and/or audio VOX SMS messages are not lost due to cellular devices, international calls, either because of hardware or connectivity Genie will generally send a duplicate message as an email to the receiving subscriber. That way, no matter what they can generally read and/or listen to their messages on their personal computers and create folders containing important messages on devices that have sufficient storage capacity.

GenieVOX—Voice SMS is a business or service provider's interesting blending of the power of Voice Messaging with the ease and flexibility of Text Messaging. VOX allows a subscriber to send and receive short SPOKEN message with one person or thousands, quickly and easily. With traditional “voice mail”, one calls someone, gets their “answering system” instead, leaves a message and waits for someone to call back, a business or service provider's Genie VOX Messaging reverses that process model. With a VOX message, a subscriber records a short message (up to 3 minutes) locally on their smart phone or personal computer FIRST, and then sets it for delivery—to one person, or to hundreds—even thousands. VOX can be used to send meeting announcements to the members of a subscriber's club, product updates to a sales team, weekly special deals to the customers of a business, etc. The related Genie “Opt-In PhoneBook” insures that the subscriber's messages are going to people who actually WANT to hear from them.

The delivery of VOX messages can also be immediate or scheduled for an appropriate time in the future. But VOX is more than simply a message delivery system. A VOX message can be the beginning of a conversation or dialogue, just as an ordinary text message can. The people who receive a VOX messages can reply with messages of their own. The a business or service provider Softswitch will also give message recipients the opportunity to call the sender right back, if the sender so chooses. This functionality also works for replies.

VOX allows subscribers to complete their calls when they ordinarily can't. When making a telephone call, if a “ring no answer” or a “busy” is reached subscribers can record a message and ask Genie to deliver it later. Genie attempts to deliver all VOX Messages at least three times, once every sixty minutes. When a VOX is delivered, Genie gives the receiving party the opportunity to: (1) listen to the message and hang up; (2) press 1, and record a response which is delivered and stored as a voicemail message; (3) press 2, and be connected to the sender of the VOX. An “Open VOX” message is sent to a specific telephone number, and will deliver the message the moment that specific telephone line is answered, regardless of who answers the call.

After the recorded message is delivered, if the call is answered by a human they will be prompted with the option to reply with a message of their own or be connected to the Genie Number of the originating sender. “Private VOX” messages are intended for a specific individual. Genie will call and announce that there is a VOX for a specific individual and ask that individual to press 1 to confirm that they are the intended party or press 4 if the party to whom the VOX is intended is not available. If the party is unavailable, Genie will call back later to attempt delivery.

Private VOX Messages will only be delivered if someone presses 1 as a response to the prompt. Genie will not deliver the VOX to Answering machines voicemail or other automated responses. After the recorded message is delivered the receiving party will be prompted with the option to reply with a message of their own or be connected to the Genie Number of the originating sender. Private VOX Messages require the sender to record the name of the receiving party or create a PhoneBook containing both telephone numbers and recorded names for future use. PhoneBooks may also contain extension numbers, which Genie will either request verbally, or enter as touch-tones when delivering the VOX. The recorded entries in the PhoneBook may also have been created using the Caller Voice Capture feature described above. In that case, when the subscriber sends a VOX to that person, Genie will announce the recipient's name in that party's own voice, clearly indicating that the VOX is actually private.

TelePaging is an interesting service that lets callers page Genie subscribers even if they don't have a pager or a cell phone. The procedure for TelePaging a subscriber is generally identical to the regular paging program. The only difference is that instead of receiving the page Genie calls the subscriber on their telephone and delivers the information as a recorded message. TelePaging can search up to three telephone numbers, for example, office, home or cell phone. The immediate benefit is that customers no longer need the additional cost or inconvenience of carrying a cell phone or a pager. And when a notification is received, subscribers can simply press the star key and connect to the paging party. With TelePaging, subscribers can also add their own comments to the message and forward the Page to any other subscriber (such as another member of their business organization) for follow-up.

In addition to the above telephone notifications TelePaging will also capture the caller's name and telephone number and send that information in an email with a way attachment containing the name of the caller. When someone wants to reach a subscriber, they can just call their toll free Genie Number, say their name and enter their phone number. Genie will call the subscriber at the number the subscriber provided, plus send a text message and email with the information left by the paging party.

The business or service provider Universal Office Platform (UO) is a proprietary Softswitch which integrates three powerful technologies into one seamless global service on the same platform. Telecommunications, the world's most universal and interactive communication medium; Electronic Banking, the key to electronic commerce; and the Internet, the world's most powerful information medium. This elegant solution is proprietary and enables a business or service provider to deliver telecommunications, internet based services and electronic banking from one source on the same platform. By moving from process to process on the same platform, rather than from system to system—or even company to company—the UO provides faster, more tightly integrated services at a lower cost than any of its multi-platform competitors.

With this combination of integration and flexibility, a business or service provider is able to easily deliver highly customized services to various niche markets on the UO, simply by turning certain individual features or feature groups on or off, without re-inventing the process. In each of the several sections below, we will look at the features and capabilities of the UO in greater detail. When reading each section, it is important to bear in mind that these are NOT separate systems, but rather different perspectives on a single, highly integrated platform.

GenieNet is the private network connecting all Genie Subscribers with secure protocol into a single cloud in which everything is “On-Net”. Genie accounts can communicate, send and receive messages, faxes, pages, to each other, and send and receive payments, in real time, without the traditional costs associated with off-net transaction. Within the GenieNet there are no long distance charges, transaction fees or the usual Off-Net third party provider fees.

Country 999 is an umbrella country code for virtual telephone numbers (International Genie Numbers) in the Genie Cloud, created to connect Genie Numbers with traditional telephones globally where VOIP phones, cell phones and land-line based traditional phones, television and computer-hosted soft phones can communicate with each other with no long distance or international telephone charges, a business or service provider offers its Subscribers three types of Genie Numbers:
Local Genie Numbers
Toll-Free Genie Numbers
International Genie Numbers

International Genie Numbers consisting of 10 digits, for example 999-123-4567, will be offered in countries worldwide, under one umbrella, country code 999, followed by seven random digits. For more detail please see Genie Numbers.

To enable callers using traditional telephones, whether cell or land line, the GenieNet provides a network of Public Access Numbers around the world, directly connected to the GenieNet. These numbers are currently in about 5,000 cities and communities, where callers can call a local number, through their local telephone network and be directly connected to the GenieNet. This connection allows them to directly connect to any of the virtual telephone numbers worldwide that exist only on the GenieNet.

Clients are created by subscribers online, in a few minutes, by accessing the Genie Gateway website. To avoid the cost and time of a manual process the “Unified Activation Program” was created. The Unified Activation Program assigns and activates a local or toll-free telephone number in real-time, integrates the proprietary protocol of the subscriber's cellular provider for receiving text and email, archives the subscriber's name, email address and the telephone numbers where they wish to receive their VOX and notifications, combined with a “Stored Value Account” and a real-time micro-payment engine.

With Unified Activation the creation of a new Client and an account on the Softswitch for a new subscriber was effectively outsourced to the subscriber instead of a call center. The following information is processed with all new activations:
Select the country in which the subscriber resides. This step will enable the Softswitch to display the cellular providers in that country so that the appropriate cellular provider is selected by the subscriber. The Softswitch contains a library of the appropriate protocols for text and email to these providers and the proper protocol is attached to the new subscribers account.
Select the level of service desired by the subscriber. Subscribers can select from free, trial, or paid services.
Enter their name. Because the name is used when creating the Genie Gateway Client and other electronic brochures the Softswitch automatically spell checks and capitalize the first character in the subscriber's first and last name. Names entered as all caps or all lower case are automatically corrected.
Enter their address. To maintain a higher quality for the database we've developed a program which compares in real-time the information entered by the new subscribers with the US Post Office records to verify that a “real and valid address” with correct zip codes and spelling was actually entered. If a bogus address is entered the subscriber is not able to establish an account and get their Genie Gateway.
Establish and setup an acceptable payment method to fund the stored value micro payment account (usually an electronic credit card/debit card payment).
   An embodiment includes the integration of one or more of:
An on-net stored value account.
A real-time monitoring and processing of the billing & micro payments generated by subscribers.
A flexible floor limit which automatically recharges the stored value balance when it dips below the selected floor limit.
A flexible recharge limit which enables subscribers to select the automatic dollars amount to maintain their stored value balance.
A velocity test monitoring charges based on the frequency and amounts on a daily, weekly and monthly basis for early detection of risk and/or fraud.
An internal negative file containing information of subscribers with previous problem records. This negative file interestingly matches payment methods with ANI, IP, SIC and the geography of the subscriber.

Activate a toll-free and when applicable a local telephone number (Genie Number) for the subscriber. Create and automatically email the subscriber their interesting Genie Gateway with instructions how to duplicate and use their Genie Gateway for their emails and electronic brochures. Create and automatically send via email An interesting snippet of code which subscribers can use to add their Genie Gateway to their websites.

Create a Real Time Response System Gateway page on our web servers, linked to the subscribers Genie Number account. Create and automatically send via email a generally unique snippet of code which the subscriber can use to place a Real Time Response System Banner on the web pages and in their emails.

The monetization of Genie Gateway services results in sub-dollar and often in penny increment transactions. Traditional billing systems are not financially logical for such small transactions. A billing event can be as little as $0.04 and traditional processing costs exceed that amount so a business or service provider was compelled to invent a real-time micro payment system to address small payments and risk management. For example if a long distance telephone call is placed by the subscriber then the calling party will be charged for each minute during the call with the final charge after they disconnect. This embodiment provided for an economic way to charge millions of micro payment transaction fees in real time in a profitable manner.

Here is how it works:

Subscribers choose a floor limit which is monitored to maintain a minimum balance of funds in their Genie Balance Account. Micro payments are presented in real time and are debited from the Genie Balance. No third party financial institutions or processors are involved as all these transactions are processed “in the GenieNet” and thus no traditional third party interchange fees are incurred. Once the balance drops below the floor limit the Micro Payment Engine automatically recharges the account by processing a charge event for a predetermined amount against a previously established external credit or debit card.

There are millions of people who fall into the “unbanked” category where they don't have checking accounts or credit cards. In today's economy there are also millions of people who prefer to pay by cash. Unfortunately these people are thus often locked out from functioning in today's mostly electronic economy. Many people resort to using prepaid (stored value) debit cards offered by several providers.

A business or service provider's type (business method) of stored value accounts integrate all of the above, the traditional “off-net” method and a business or service provider's GenieNet method, enabling stored value account holders to use their accounts in the traditional way plus participate in a community where they can send and receive payments to and from all other subscribers in real time, free of any charges from third party providers. This is a perfect example where telephone, money and the internet are integrated into one seamless service on the Universal Office platform.

In addition, a business or service provider has integrated a “brick and mortar” element to its Stored Value program by inventing “Deposit Service.com” enabling subscribers to login to their accounts online, select from a list of participating banks, print a special deposit slip which contains their stored value account information, and therewith deposit a cash payment which will be credited to their stored value account.

A business or service provider's stored value accounts work just like the traditional stored value, prepaid debit cards do plus when used in the GenieNet the special features of real time peer-to-peer payments with no processing fees, and the ability to use Deposit Service.com to deposit additional sums to their stored value account.

The OptIn icon (button) is an application created to produce, on demand, a personalized icon much more than just a picture: It includes special codes that allow someone to click on this button and be instantly added to a subscriber's information distribution lists, their SendTEXT, SendWAV and Opt-In PhoneBooks.

What is the OptIn Button?

The OptIn Button is the one-click way for people to opt in to receive a subscriber's updates and announcements. Subscribers can send their messages anytime, free, to one or thousands with a single click, in the three most common methods of communication, voice, text, and email.

How does it Work?

When someone clicks on an OptIn Button they will be asked to enter their name, telephone number and email address. Once they complete this process they will automatically be added to the subscriber's SendTEXT and Main PhoneBooks. That way, they can send them their announcements, deals, news and updates anytime. Plus they will automatically receive a free Genie Gateway Lite.

How Much does it Cost?

The OptIn Button is a free service to all Genie subscribers and it is also free to anyone who opts in to receive a subscriber's messages.

Where can Subscribers Use the OptIn Button?

OptIn icons can be copied into the body of most commercially available email documents, websites, electronic brochures, coupons, or word processor created documents and spreadsheets.

The ‘OPT-IN’ PhoneBook is an application created to enable subscribers to take control of their voice messaging—both what they SEND and what they RECEIVE. PhoneBooks enable subscribers to send messages to many people at once. The addition of the Opt-In Phonebook assures that recipients have actively indicated that they wish to receive messages from a given subscriber.

The intent of VOX Messages, in the subscriber's own voice and received over the phone, is to provide a more personal and compelling communication than ‘text’ messages and to make such messaging available to everyone, even those who aren't yet comfortable with texting. However, in the current business climate of SPAM emails and telemarketing calls, subscribers are properly concerned about sending messages to people who don't want them!

The Opt-In Center lets people call a subscriber's Genie number and add themselves to a new Opt-In Phone Book. Special security features ensure that only those screened and approved are added to a subscriber's Opt-In list and no one can add someone else. To avoid unsolicited or unwanted Opt-Ins, subscribers receive an email with the caller's phone number and the name they recorded. Then the subscriber can call their Genie Number and approve the addition. Thus, both the service subscriber and the person who Opts-In know that the subscriber's messages and announcements are something they really did ask to receive. The Opt-In Center also allows someone who has Opted-In to a particular subscriber's messaging, to Opt-Out generally at any time. An Opt-Out event also generates a notification email to the subscriber, but does not require a follow-up approval step.

The SendTEXT PhoneBook is an application created to enable subscribers to send text messages from any internet connected device with a keyboard to one or to thousands of individuals who opted in to receive the subscriber's messages. SendTEXT PhoneBooks enable subscribers to send text messages to many people at once. The addition of the SendTEXT Phonebook assures that recipients have actively indicated, by using the Opt-In Button, that they wish to receive text messages from a given subscriber. The Opt-In Button, together with the SendTEXT PhoneBook, addresses the current business climate of SPAM texting, for subscribers who are properly concerned about sending messages to people who don't want them! The SendTEXT PhoneBook lets people opt in by clicking on the subscriber's Opt-In Button and adding themselves to the new SendTEXT PhoneBook.

SendWAV is an application created to combine telephone messaging and email into one system, providing subscribers the ease of speaking on the telephone and automatically delivering their messages free, worldwide, as an email attachment. The SendWAV PhoneBook enables subscribers to send audio messages from any telephone internet connected device with a keyboard, to one or to thousands of individuals who opted in to receive the subscriber's messages. The SendWAV PhoneBook also provides a web interface which enables senders to select an existing audio, WAV or MP3 file, from their database and automatically send that file to everyone in their SendWAV PhoneBook. The ability to convey voice messages to individuals in a language of their choice, worldwide, with ease, and free of charge, prompted this embodiment.

SendPDF is an application created to remove the obstacles and challenges people have when sending Microsoft Office (Word, Excel, PowerPoint, and Publisher), Open Office, TXT, JPG, TIF and old versions of PDF files, to devices that can't display them. Many email programs, and especially wireless devices, do not display the above file types. However almost all devises and programs will display PDF files. With a few clicks, SendPDF enables subscribers to find a document in their database, and automatically send it as a PDF attachment to one or all the people who opted in to receive their messages and updates. SendPDF provides a web interface which enables senders to select an existing file and automatically send that file to everyone in their SendWAV PhoneBook. The ability to send the above variety of file types in a commonly readable format, worldwide, with ease, and free of charge, prompted this embodiment.

The Viral Brochure is an automated marketing tool developed by a business or service provider specifically for viral marketing. What is interesting about this embodiment is that each brochure is “one of a kind” and is prepared for the occasion. The sender provides their name, Genie Number, email address, the name and email address of the receiving party. From this information, the program creates a one of a kind personalized brochure addressed directly to the receiving party from the sending party, including signup instructions that automatically contain the sender's referral number (their Genie Number). The program will even create a professionally written cover letter on behalf of the sender and will email the viral brochure as a PDF document attached to the email. Viral brochures may be created containing information on any of a business or service provider's various service packages. Which of the available brochures is prepared depends solely on which product website the sender is using.

In one embodiment, a Genie Gateway is a digital buffet of elegant business solution delivered from a single source on a single platform in a single cloud. An interesting approach in this invention is that information moves from process to process on the same platform, rather than from system to system—or even from provider to provider. This approach delivers faster, more tightly integrated services with security, privacy, and safety, at a lower cost than any multi-platform competitors or a collection of various providers.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope.

For example, although the figures illustrate a genie gateway module having particular sub-modules, it is understood that the various embodiments of the genie gateway module may include one or more of the described modules and/or may exclude one or more of the described modules and/or may include non-named or non-described modules and/or may exclude one or more non-named or non-described modules.

Additionally, although the figures illustrate particular screenshots, it is understood that the interfaces that may embody the invention are plethoric and of great variety in appearance, layout, and the like.

It is also envisioned that the various embodiments of the invention may be implemented in a great variety of modes for a great variety of purposes, including but not limited to for social media purposes, business purposes, public relations purposes, marketing and advertising purposes, family connection purposes, government management purposes, intercontinental communication purposes, non-governmental entity purposes, and the like and combinations thereof.

Finally, it is envisioned that the components of the device may be embodied in a variety of modes, including but not limited to as a commercial web-site design wizard for use by the general public; as a tool for rapid deployment of business resources of an organization; as a tool for consistent deployment of multi-level marketing business interfaces among participants; as a communications tool for NGOs, government groups, cause-related organizations, businesses, families, nations, and the like and combinations thereof; and as a viral marketing tool and combinations thereof.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims. Further, it is contemplated that an embodiment may be limited to consist of or to consist essentially of one or more of the features, functions, structures, methods described herein.

1. An automated communication system, comprising:
a. a website template including a base website design including both functional internet and functional phone communication features, and executable machine-readable software instructions for automatically producing a customized website by using the base website design, user metadata from a user account, and media information;
b. a network bridge functionally coupled to each of a network data system and a phone data system and thereby functionally coupling the network data system to the phone data system;
c. a bridge controller functionally coupled to the website template and operatively coupled to the network bridge and that includes instructions for managing data transfer across the network bridge that permit control of the functional phone communication features via interaction with the customized website produced from the website template; and
d. a user account module in communication with the bridge controller and that includes account information of system users on a data storage device.

2. The system of claim 1, wherein the website template further includes a telephone module including machine-readable software instructions for initiating a telephone call via a website.

3. The system of claim 2, wherein the website template further includes machine-readable software instructions for creating a clickable link associated with a telephone number, wherein the link includes machine-readable software instructions for launching a communication application that electronically contacts an account associated with the telephone number.

4. The system of claim 3, wherein the website template further includes a SMS application that includes machine-readable software instructions for sending a message in a text message format over a cellular service's email protocol at a user interface instruction from a user.

5. The system of claim 4, wherein the website template includes machine-readable software instructions for creating an active link on a website that automatically, sends a text message or a voice message to a telephone number over a phone service.

6. The system of claim 5, wherein the website template includes a user account page that includes machine-readable software instructions for providing, to a user, access to the user's phone messages over a non-phone network.

7. An automated communication system, comprising:
a. a website template including:
i. a base website design including both functional internet and functional phone communication features;
ii. machine-readable software instructions for creating a clickable link telephone number, the link including machine-readable software instructions for launching a communication application that electronically contacts an account associated with the telephone number;
iii. executable machine-readable software instructions for automatically producing a customized website by using the base website design, user metadata from a user account, and media information;
iv. telephone instructions including machine-readable software instructions for initiating a telephone call via a website;
v. an SMS application that includes machine-readable software instructions for sending a message in a text message format over a cellular service's email protocol at a user interface instruction from a user; and
vi. machine-readable software instructions for creating an active link on a website that automatically, sends a text message or a voice message to a telephone number over a phone service;
b. a network bridge functionally coupled to each of a network data system and a phone data system and thereby functionally coupling the network data system to the phone data system;
c. a bridge controller functionally coupled to the website template and operatively coupled to the network bridge and that includes instructions for managing data transfer across the network bridge that permit control of the functional phone communication W features via interaction with the customized website produced from the website template;
d. a user account module in communication with the bridge controller and that includes account information of system users on a data storage device; and
e. website customization instructions configured to permit a user having a user account stored thereon to supply media information and user metadata for display and operation, respectively, on a website built across the base website design of the website template.
